(19) United States
(12) Patent Application Publication
(10) Pub. No.: US 2026/0233099 A1
(43) Pub. Date: Aug. 13, 2026

(54) COMPUTER SYSTEM AND CONTROL METHOD

(71) Applicant: Bandai Namco Entertainment Inc., Tokyo (JP)

(72) Inventors: Kazutoki KONO, Tokyo (JP); Manabu SHIMOMOTO, Tsukubamirai-shi (JP); Yusuke TSUTSUMI, Tokyo (JP); Ryunosuke HAGIWARA, Kashiwa-shi (JP); Tatsuki NONOMURA, Tokyo (JP); Masahide KITO, Tokyo (JP); Masashi KOYANAGI, Matsudo-shi (JP); Masato KANNO, Tokyo (JP); Kosuke ITOMI, Tokyo (JP)

(73) Assignee: Bandai Namco Entertainment Inc., Tokyo (JP)

(21) Appl. No.: 19/566,096

(22) Filed: Mar. 13, 2026

Related U.S. Application Data
(63) Continuation of application No. PCT/JP2024/033109, filed on Sep. 17, 2024.

(30) Foreign Application Priority Data
Sep. 28, 2023 (JP) 2023-166819

(51) Int. Cl. A63F 13/577; A63F 13/56; A63F 13/573; A63F 13/58; A63F 13/837

(52) U.S. Cl. CPC A63F 13/577; A63F 13/56; A63F 13/573; A63F 13/58; A63F 13/837

(57) ABSTRACT

A computer system moves a damaged object of an enemy aircraft that has been hit by a missile of a player aircraft and has been shot down, so that the damaged object falls. The computer system sets a movement-target object corresponding to the damaged object based on a specific parameter value Ps. The movement of the damaged object is controlled so that the damaged object falls along a trajectory in which the damaged object collides with the movement-target object. When the damaged object comes into contact with or approaches the movement-target object, the computer system performs a collateral damage display for the movement-target object.

### CROSS REFERENCE TO RELATED APPLICATIONS

This application is a continuation of International Patent Application No. PCT/JP2024/033109, having an international filing date of September 17, 2024, which designated the United States, the entirety of which is incorporated herein by reference. Japanese Patent Application No.2023-166819 filed on September 28, 2023 is also incorporated herein by reference in its entirety.

### BACKGROUND OF THE INVENTION

In shooting games, which are one of the popular genres of video games, secondary effects such as game developments or presentations corresponding to damage inflicted or damage received have been considered one of the important game elements.

For example, Japanese Unexamined Patent Application Publication No. 2010-72768 describes a technique regarding a secondary effect in which, when a bullet fired from a gun of a player object hits an enemy character, a predetermined amount of damage is given to the enemy character, and the bullet ricochets from the enemy character and hits other nearby object (a wooden box), thereby secondarily causing damages.

Examples of such secondary effects are not limited to “ricochets.” For example, in a game involving aerial combat between fighter aircraft, a damaged enemy fighter aircraft may lose control and crash, or may break into several pieces that scatter and fall, thereby causing “collateral destruction” such as exploding while involving buildings or other objects at the crash site.

However, generating such secondary effects like the “collateral destruction” caused by a fighter aircraft requires complex techniques. This is because, for such effects, a relatively simple technique like the “ricochet” in conventional technologies cannot be readily applied. Even in regard to falling, numerous variations are required, such as cases in which a fighter aircraft crashes while retaining its original shape, and cases in which the fighter aircraft breaks into several pieces that scatter as they fall.

For example, in the case where a fighter aircraft falls while retaining its original shape, it is desirable to present a realistic falling trajectory such as one forming a parabolic curve or one with a spiraling movement. In the case where the fighter aircraft breaks into several pieces that scatter as they fall, it is preferable to present a falling trajectory of an unpredictable turning or a falling trajectory in a zigzag patten, so as to evoke the impression that the complex shapes of the separated parts cause varying air resistance during the fall. Depending on the size of the part separated from the fighter aircraft and the weight assigned in the game settings, a falling trajectory that drops almost vertically may appear more realistic than parabolic motion, whereas in some cases, reaching a distance farther than that achieved by a parabolic trajectory may appear more realistic.

In cases where various variations are present as secondary effects, such as the example of “collateral destruction” of a fighter aircraft, techniques capable of handling such variations have been required. The same applies also to other examples than the “collateral destruction” of fighter aircraft. For example, in the case of generating secondary effects in a situation where a race car receives damage due to contacting other object while driving, and then crashes and breaks apart and scatters, various secondary effects are possible. However, in conventional techniques, secondary effects corresponding to damage inflicted or damage received were generally simple and were designed to produce predetermined effects. Accordingly, the conventional techniques did not produce various types of secondary effects in accordance with damage inflicted or damage received.

### BRIEF DESCRIPTION OF THE DRAWINGS

FIG. 1 is a system configuration diagram illustrating a configuration example of a game system.

FIG. 2 is a diagram for describing a game executed by a game system.

FIG. 3 is a diagram for describing damage display related to an enemy aircraft that has been shot down.

FIG. 4 is a diagram for describing damage display related to an enemy aircraft that has been shot down.

FIG. 5 is a diagram for describing setting of a damaged object.

FIG. 6 is a diagram for describing setting of a specific parameter value.

FIG. 7 is a diagram for describing an example of variables of a function for obtaining a specific parameter value.

FIG. 8 is a diagram illustrating an example of a collateral damage display in the absence of a priority setting.

FIG. 9 is a diagram for describing control of “collateral destruction” based on a specific parameter value.

FIG. 10 is a diagram illustrating a display example of a game screen.

FIG. 11 is a block diagram illustrating a functional configuration example of a server system.

FIG. 12 is a diagram illustrating an example of programs and data stored in a server storage section.

FIG. 13 is a diagram illustrating a data configuration example of enemy aircraft initial setting data.

FIG. 14 is a diagram illustrating a data configuration example of ground object initial setting data.

FIG. 15 is a diagram illustrating a data configuration example of play data.

FIG. 16 is a diagram illustrating a data configuration example of collateral damage management data.

FIG. 17 is a functional block diagram illustrating a functional configuration example of a user terminal.

FIG. 18 is a flowchart for describing a processing flow executed by a server system.

FIG. 19 is a flowchart continued from FIG. 18.

FIG. 20 is a flowchart continued from FIG. 19.

FIG. 21 is a diagram illustrating a functional configuration example of a user terminal according to a second embodiment.

FIG. 22 is a diagram for describing a modification example.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being "connected" or "coupled" to a second element, such description includes embodiments in which the first and second elements are directly connected or coupled to each other, and also includes embodiments in which the first and second elements are indirectly connected or coupled to each other with one or more other intervening elements in between.

A first disclosure is a computer system comprising at least one processor or circuit programmed to perform:

setting a specific parameter value that is referenced during movement control of a damaged object that moves upon receiving damage in a virtual space;

a movement control of the damaged object with reference to the specific parameter value; and

an impact display control that indicates reception of impact by other object when a given positional relationship condition is satisfied, the positional relationship condition being based on approach or contact of the damaged object and the other object due to the movement control.

According to the disclosure, in some embodiments, the computer system sets a specific parameter value that is referenced during the movement control of the damaged object that moves upon receiving damage. Then, the movement control of the damaged object is performed with reference to the specific parameter value. The computer system can express a state in which other object is affected by the damaged object by performing impact display control on the other object to which the damaged object has approached or contacted as a result of the movement control. Accordingly, the movement of the damaged object after it receives the damage varies in different ways depending on the specific parameter value. As a result, various secondary effects occur in accordance with the damage inflicted or damage received.

A second disclosure is the computer system, wherein

a predetermined gravity field is provided in the virtual space, and

the movement control gradually moves the damaged object in a direction of gravity based on the gravity field.

According to the second disclosure, in some embodiments, the computer system can achieve an expression in which the damaged object “falls” after receiving damage and exerts an impact on other object.

A third disclosure is the computer system wherein

the damaged object is any one of:
(1) an original object before receiving the damage;
(2) a partial object that is a part of the original object generated by decomposition or scattering upon receiving the damage; and
(3) a replacement object that is used after the original object is decomposed or scattered upon receiving the damage.

According to the third disclosure, in some embodiments, the computer system can express the damaged object in any one of: a state in which an original form before receiving the damage is maintained, a state in which the damaged object is decomposed or scattered due to the damage, and a state expressed by a replacement object that is used after the decomposition or scattering. That is, the damaged state can be visually expressed in a variety of manners. For example, in a scattered state, the number of damaged objects increases compared with the number of original objects before receiving the damage, and the impact display control is performed for each of the damaged objects, thereby enabling a more spectacular display effect.

A fourth disclosure is the computer system, wherein the setting the specific parameter value includes setting the specific parameter value based on at least one of a type, a physical quantity, performance, and a state of the original object.

As for the type, the physical quantity, the performance, and the state of the original object, for example, when the original object is a fighter aircraft, the physical quantity corresponds to an airframe dimension, an airframe weight, and the like. The performance corresponds to, for example, a weapon loadout type, a weapon loadout amount, a fuel load amount, the number of mounted engines, the maximum speed, the maximum acceleration, and the like. The state corresponds to, for example, the amount of damage already received, the remaining number of weapons, remaining fuel, and the like. These factors greatly affect how the damaged state after receiving the damage is expressed.

According to the fourth disclosure, in some embodiments, the computer system can diversify the causes of secondary effects that occur in accordance with damage inflicted or damage received.

A fifth disclosure is the computer system, wherein

a plurality of objects serving as the other object are present in the virtual space, and

the impact display control includes performing the impact display control for the other object that satisfies the positional relationship condition from among the plurality of objects.

According to the fifth disclosure, in some embodiments, the computer system can perform the impact display control selectively for the other object that satisfies the positional relationship condition from among the plurality of objects serving as the other object.

A sixth disclosure is the computer system, wherein the setting the specific parameter value includes setting the specific parameter value corresponding to each of the plurality of objects serving as the other object based on at least one of a priority, a type, a physical quantity, performance, and a state of the other object.

According to the sixth disclosure, in some embodiments, the computer system can set a specific parameter value that reflects, for each of the other object, the priority, the type, the physical quantity, the performance, and the state.

A seventh disclosure is the computer system, wherein the at least one processor or circuit is programmed to perform a prediction display control includes performing the prediction display of a direction and/or a trajectory in which the damaged object moves due to the movement control,

wherein the prediction display control includes predicting the other object that satisfies the positional relationship condition due to the movement control, and controlling the prediction display based on the specific parameter value corresponding to the other object in a variable manner.

According to the seventh disclosure, in some embodiments, the computer system can perform the prediction display of a direction and/or a trajectory in which the damaged object moves due to the movement control by the movement control section based on the specific parameter value.

An eighth disclosure is the computer system, wherein the at least one processor or circuit is programmed to perform an identifiable display for each of the plurality of objects serving as the other object based on the specific parameter value corresponding to the other object.

According to the eighth disclosure, in some embodiments, the computer system can perform the identifiable display for each of the other object based on the specific parameter value.

A ninth disclosure is the computer system, wherein the movement control includes

selecting a movement-target object with which the other object serves as a movement target for the damaged object using the specific parameter value corresponding to each of the other object, and

a control to move the damaged object toward the movement-target object.

According to the ninth disclosure, in some embodiments, the computer system can set the movement-target object for the damaged object based on the specific parameter value. This allows the damaged object to appear to move toward the movement-target object.

A tenth disclosure is the computer system, wherein the at least one processor or circuit is programmed to perform setting the specific parameter value includes setting the specific parameter value based on at least one of a type, a physical quantity, performance, and a state of a damage-inflicting object that has inflicted the damage.

According to the tenth disclosure, in some embodiments, the computer system can set a specific parameter value that reflects the differences in the type, the physical quantity, the performance, and the state of the damage-inflicting object that has given the damage. Thus, the movement control and the impact display control become more diverse.

An eleventh disclosure is the computer system, wherein

the virtual space is a game space, and

the setting the specific parameter value includes setting the specific parameter value based on a game situation.

According to the eleventh disclosure, in some embodiments, it is possible to set the specific parameter value based on the game situation.

A twelfth disclosure is the computer system, wherein

the setting the specific parameter value includes setting the specific parameter value based on a game situation, which is at least one of: (1) a distance between the damaged object and the other object, (2) a damage history of the damaged object, (3) a number of occurrences of the damage, (4) an interval of occurrences of the damage, (5) an elapsed time since last occurrence of the damage, (6) a history of executions of the impact display control, (7) a number of times the impact display control is executed, (8) an interval at which the impact display control is executed, and (9) an elapsed time since last execution of the impact display control.

According to the twelfth disclosure, in some embodiments, the computer system can set the specific parameter value based on various game situations.

A thirteenth disclosure is the computer system wherein

the movement control includes performing control to move the damaged object along a given direction based on a direction in which the damage was received.

According to the thirteenth disclosure, in some embodiments, the computer system can move the damaged object based on the direction in which the damage is received.

A fourteenth disclosure is the computer system, wherein the at least one processor or circuit is programmed to perform a prediction display of a direction and/or a trajectory in which the damaged object moves due to the movement control.

According to the fourteenth disclosure, in some embodiments, the computer system can perform the prediction display of a direction and/or a trajectory in which the damaged object moves.

A fifteenth disclosure is the computer system, wherein

the impact display control includes controlling whether or not to perform the impact display control using the specific parameter value.

According to the fifteenth disclosure, in some embodiments, the computer system can determine whether or not to perform the impact display control by using the specific parameter value. Therefore, diversity can be introduced into damage-related display effects such that, in some cases, the other object is affected by the damaged object, while in other cases, the other object is not affected by the damaged object, depending on the specific parameter value.

A sixteenth disclosure is a control method for a computer system to perform control for generating an image of a virtual space, the method comprising:

setting a specific parameter value that is referenced during movement control of a damaged object that moves upon receiving damage;

performing the movement control of the damaged object with reference to the specific parameter value; and

performing impact display control that indicates reception of impact by other object when a given positional relationship condition is satisfied, the positional relationship condition being based on approach or contact of the damaged object and the other object due to the movement control.

According to the sixteenth disclosure, in some embodiments, it is possible to achieve a control method that allows the computer system to exert the same advantageous effects as those of the above-described disclosures.

Exemplary embodiments are described below. Note that the following exemplary embodiments do not in any way limit the scope of the content defined by the claims laid out herein. Note also that all of the elements described in the present embodiment should not necessarily be taken as essential elements.

Hereinafter, examples of embodiments of the present invention will be described. Note that modes to which the present invention is applicable are not limited to the following embodiments.

### First Embodiment

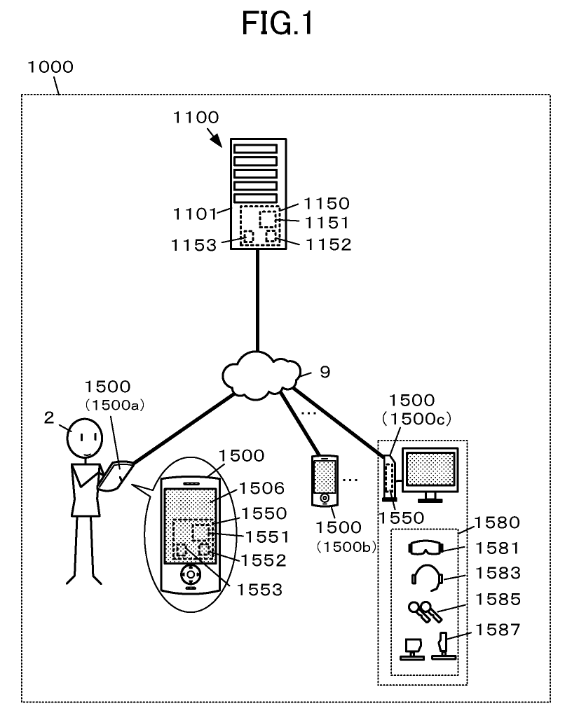

FIG. 1 is a system configuration diagram illustrating a configuration example of a game system according to the present embodiment.

The game system 1000 is a computer system for executing a given online game in which a player 2, who is a user, operates a player character to play the game.

The game system 1000 is a computer system including a server system 1100 and user terminals 1500 (1500a, 1500b, ...) for individual users, which are connected so as to be capable of data communication via a network 9. The user terminals 1500 serve as man-machine interfaces (MMIFs).

The network 9 refers to a communication channel that allows data communication. That is, examples of the network 9 include a private line (private cable) for direct coupling, a local area network (LAN) based on Ethernet (registered trademark), a telecommunication network, a cable network, the Internet, and the like.

The server system 1100 is a game server that performs various processes such as providing a predetermined registration procedure, managing information of registered users, and generating and managing various types of data for executing the game.

The server system 1100 has a control board 1150 mounted on a main body device. The control board 1150 is mounted with, for example, a microprocessor that varies in type such as a central processing unit (CPU) 1151, a graphics processing unit (GPU), or a digital signal processor (DSP), an integrated circuit (IC) memory 1152 that varies in type such as a video random access memory (VRAM), a random access memory (RAM), or a read-only memory (ROM), and a communication device 1153. The functions mounted on the control board 1150 may be implemented partially or entirely by an application specific integrated circuit (ASIC), a field-programmable gate array (FPGA), or a system on a chip (SoC).

The server system 1100 is illustrated as including only one server device. However, the server system 1100 may be implemented by a plurality of devices. For example, the server system 1100 may be configured such that a plurality of blade servers are connected together via an internal bus in a manner capable of data communication to share the functions. The server system 1100 may also include a database and online storage.

The user terminal 1500 is a computer system that is used by the player 2 to participate in an online game, and functions as a man-machine interface in the game system 1000.

The user terminal 1500 (1500a, 1500b, ...) is a computer system connectable to the network 9, such as a personal computer, a smartphone, a wearable computer, a portable game device, a consumer game device, or a tablet computer.

For example, the user terminal 1500a and the user terminal 1500b are illustrated as smartphones in this example. The user terminal 1500a and the user terminal 1500b each include an operation input device, an image display device, and a control board 1550. Examples of the operation input device include a touch panel 1506, a keyboard, a game controller, and a mouse. Examples of the image display device include a touch panel 1506, a head-mounted display, and a glasses-type display.

The control board 1550 includes a microprocessor of various types such as a CPU 1551, a GPU, or a DSP, an IC memory 1552 of various types such as a VRAM, a RAM, or a ROM, a communication module 1553 that connects to the network 9. These elements mounted on the control board 1550 are electrically connected with each other via a bus circuit or the like to be capable of reading/writing data and exchange signals. The control board 1550 may be partially or entirely implemented by an ASIC, an FPGA, or an SoC.

The control board 1550 causes the IC memory 1552 to store programs and various types of data for implementing a function as the user terminal 1500. The user terminal 1500 executes a predetermined application program to implement the functions of a man-machine interface (MMIF) for the game system 1000 and a client for an online game.

The user terminal 1500c is a type of terminal that is used while connected to a monitor. In this example, the user terminal 1500c is illustrated as a desktop personal computer or a consumer game device communicably connected to a VR (Virtual Reality) MMIF set 1580. The VR MMIF set 1580 includes a VR goggle 1581, a VR headset 1583, a VR controller 1585, a flight controller set 1587 having a joystick and a throttle lever, and the like. Note that the user terminal 1500a and the user terminal 1500b may also have a configuration including the VR MMIF set 1580.

The user terminal 1500 is configured to download programs and various types of data necessary to play a game from the server system 1100. Alternatively, the user terminal 1500 may be configured to read them from a storage medium such as a memory card obtained separately by the user.

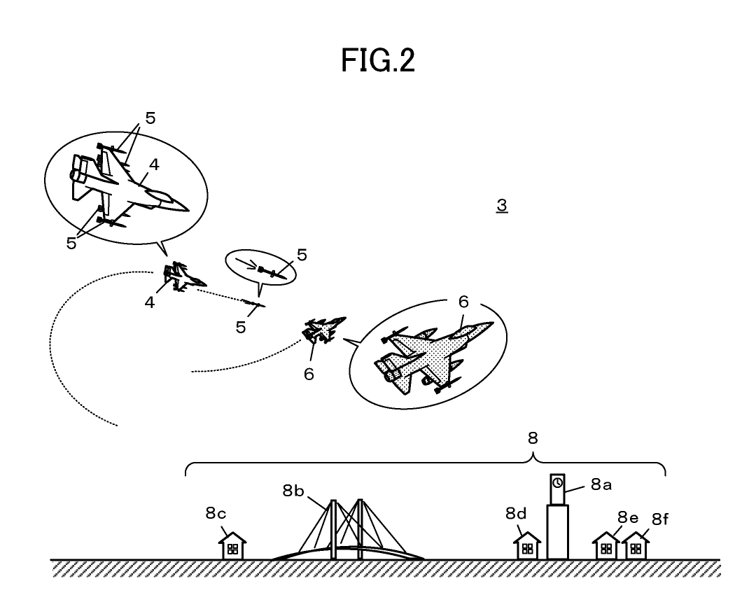

FIG. 2 is a diagram for describing a game executed by the game system 1000.

The game executed by the game system 1000 is a shooting game themed on aerial combat and ground attacks using fighter aircraft. In a game space 3, which is a virtual three-dimensional space in which various objects are disposed, the player operates a player aircraft 4 (player character; player object). The player selects and fires a missile 5 (a projectile object) of a type appropriate to the situation from among the missiles 5 mounted on the player aircraft 4. The player aims to destroy enemy aircraft 6 (NPC; attack-target objects) that are computer-controlled, as well as designated ground objects 8 (8a, 8b, …).

In the example of FIG. 2, a clock tower 8a, a bridge 8b, and general buildings 8c to 8f are illustrated as the ground objects 8. The clock tower 8a and the bridge 8b have sizes and designs that make them stand out among the ground objects 8. Further, they are also assigned settings that are important from a tactical viewpoint as attack targets. For example, the clock tower 8a and the bridge 8b are located on the advance route of enemy ground forces. The ground objects 8 may be objects other than those described above. For example, the ground objects 8 may be enemy combat vehicles, ammunition depots, factories, military bases, military airports, naval port facilities, field artillery, and the like. Depending on the design of the game space 3, the ground objects 8 may be maritime objects (for example, port facilities, ships, offshore facilities, and the like). The ground objects 8 and the maritime objects may be present in combination.

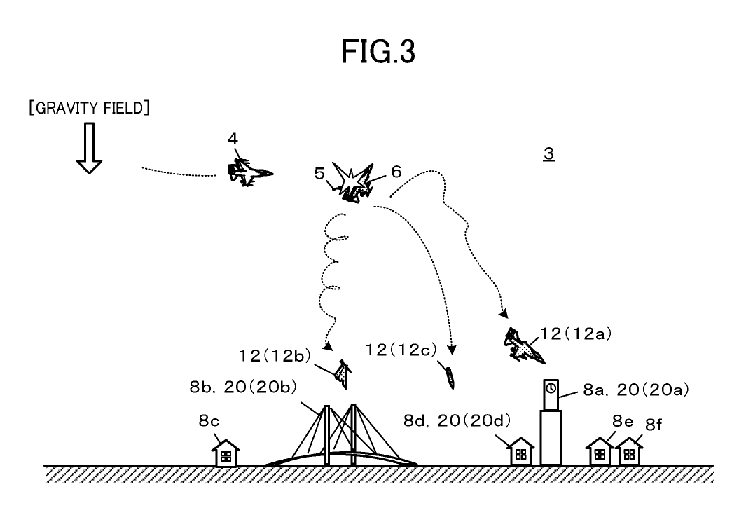

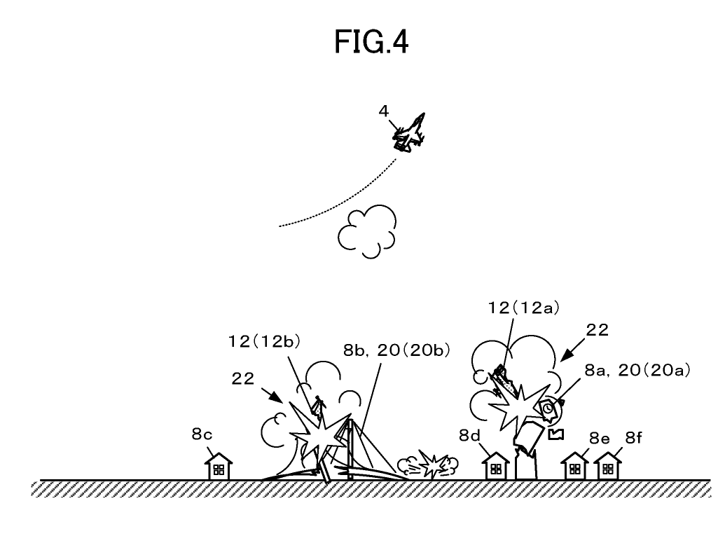

FIG. 3 and FIG. 4 are diagrams for describing damage display related to the enemy aircraft 6 that has been shot down.

As shown in FIG. 3, when the missile 5 hits the enemy aircraft 6, a given hit damage is applied to the enemy aircraft 6. Specifically, a hit damage amount is calculated, and the hit damage amount is subtracted from the hit point of the enemy aircraft 6. When the hit point of the enemy aircraft 6 reaches “0,” the enemy aircraft 6 is shot down.

The enemy aircraft 6 that has been shot down is changed from an original object (an object representing an undamaged airframe) before receiving damage to a damaged object 12 (12a, 12b, …) that has received damage. In the example of FIG. 3, the aircraft is divided into three parts: a damaged body 12a, a separated left-wing portion 12b, and an unused weapon 12c that has detached from the airframe (for example, the missile 5 or a drop-type bomb that had been mounted under the wing).

A gravity field is set in the game space 3. The damaged objects 12 (12a, 12b, …) are gradually moved along the direction of gravity (indicated by the thick white arrow) based on the gravity field. This is referred to as “damaged movement control.” Specifically, the movements of the damaged objects 12 are controlled so that the damaged objects 12 fall toward the ground or the sea in the game space 3.

For each damaged object 12, a movement-target object 20 selected from among the ground objects 8 is associated, and movement control is performed so that the damaged object 12 moves toward the movement-target object 20. In the example of FIG. 3, the damaged body 12a is associated with a clock tower 8a serving as a movement-target object 20a. The left-wing portion 12b is associated with a bridge 8b serving as a movement-target object 20b, and an unused weapon 12c is associated with a general building 8d serving as a movement-target object 20d.

As shown in FIG. 4, during the damaged movement control, when the damaged object 12 comes into contact with or approaches an associated movement-target object 20, it is determined that a predetermined positional relationship condition is satisfied. Then, collateral damage is applied to the associated movement-target object 20. Further, in accordance with the collateral damage amount, control of impact display indicating that the movement-target object 20 has been affected by the damaged object 12 is performed. For example, a collateral damage display 22 is displayed.

The content of the collateral damage display 22 varies depending on the accumulation of collateral damage received by the movement-target object 20 (which may be represented as a remaining hit point obtained by subtracting the collateral damage amount from an initial hit point).

For example, when the accumulation of collateral damage is small, as the collateral damage display 22, a dust-cloud effect representing the occurrence of a collision may be displayed, or the movement-target object 20 may be partially destroyed. When the accumulation reaches a medium level, as the collateral damage display 22, smoke or flame effects representing the occurrence of a fire may be displayed, or the movement-target object 20 may be half-destroyed. When the accumulation of collateral damage reaches a limit and the remaining hit point reaches “0,” the movement-target object 20 (the movement-target objects 20a and 20b in the example of FIG. 4) is regarded as having been destroyed. Accordingly, in this case, as the collateral damage display 22, the movement-target object 20 is completely destroyed. This damage may be presented as having been burned down by a fire.

By presenting, within the game, such “collateral destruction” in which debris from aerial combat falls onto the ground or the sea and causes damage to buildings or the like located in that area, it is possible to enhance the realism of the game world and to increase game-specific entertainment, such as a sense of exhilaration derived from a chain of destruction.

Although the display effect of the “collateral destruction” can be made by preparing presentation patterns in advance and applying them in common, such a method results in fixed presentation of display effect and may detract from player engagement. Therefore, the server system 1100 controls various factors that influence the embodiment of “collateral destruction” in accordance with the situation at each moment, thereby providing diversity to the “collateral destruction”.

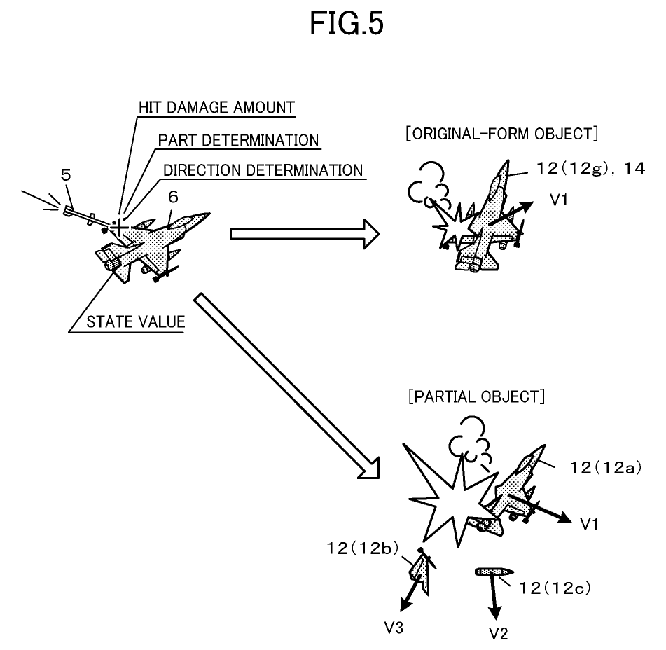

FIG. 5 is a diagram for describing the setting of damaged object of the enemy aircraft 6, which is one of the factors that influence the embodiment of “collateral destruction.”

When the missile 5 hits the enemy aircraft 6, the server system 1100 performs part determination to determine which part of the enemy aircraft 6 has been hit by the missile 5, and direction determination to determine from which relative direction the enemy aircraft 6 has been hit by the missile 5. Then, based on the type and performance of the missile 5 that hit the enemy aircraft 6, the result of the part determination, the result of the direction determination, and the state of the enemy aircraft 6, the damaged object 12 is set.

The damaged object 12 is either an “original-form object” or a “partial object.”

The “original-form object” has the same object configuration as that of the original object 14 before the enemy aircraft 6 receives damage. In the example of FIG. 5, a damaged object 12g corresponds to this case. The damaged object 12g may be created by changing a standard skin of the original object 14 to a dirtied skin to which dirt caused by destruction has been applied. Alternatively, the damaged object 12g may be created by replacing the original object 14 with other replacement object prepared in advance. The damaged object 12g that is an original-form object is preferably selected when expressing a situation in which damage to the airframe is minor but the aircraft becomes actually uncontrollable, or the aircraft crashes due to a loss of thrust.

The “partial object” represents a state in which the airframe or weapons of the enemy aircraft 6 are broken apart due to damage. In the example of FIG. 5, the damaged body 12a, the left-wing portion 12b, and the unused weapon 12c (such as a missile 5 or a drop-type bomb that had been mounted under the wing) correspond to damaged objects 12 that are partial objects. The damaged objects 12 that are the partial objects may be represented by releasing the coupling of parts constituting the original object 14 and subsequently enabling the parts to be individually controlled in their movement. Alternatively, the damaged objects 12 as the partial objects may be created by replacing the original object 14 with replacement objects that had been separately prepared.

Note that the configuration and the number of the partial objects of the enemy aircraft 6 are not limited to those in the example shown in FIG. 5. Which object parts constituting the enemy aircraft 6 are divided, and into how many parts they are divided, are determined depending on the situation at the time. For example, when the result of determining the damaged part indicates a part such as a wing tip or a cockpit, the damage is regarded as minor damage to an extent that merely causes loss of control, and the damaged object 12 is set as an “original-form object.” On the other hand, when the result of determining the damaged part indicates a part such as a fuselage, an engine, a central portion of a main wing, or an unused weapon, the damage is regarded as major damage, and the damaged object 12 is set as a “partial object.”

Further, when the damaged object 12 is set as a “partial object,” (1) how many partial objects are to be set and (2) into which parts constituting the original object 14 the damaged object 12 is to be decomposed are determined.

Specifically, the original object 14 of the enemy aircraft 6 is configured by connecting a plurality of parts in a hierarchical structure. For each part, a predetermined decomposition requirement to be satisfied in order for the part to be separated from an upper-level part as the damaged object 12 is set. When the decomposition requirement is satisfied, the corresponding part is separated from the upper-level part, and, together with other parts belonging to a lower level of that part, is regarded as one damaged object 12.

The “decomposition requirement” is defined using at least one of: (1) a part determination subcondition described by a part name indicated by the result of part determination, (2) a direction determination subcondition described by a direction range indicated by the result of direction determination, (3) a state subcondition described by a range or a threshold of a state parameter value of the enemy aircraft 6, and (4) a hit damage amount subcondition described by a range or a threshold of a hit damage amount applied to the enemy aircraft 6.

The server system 1100 determines a scattering speed V (V1, V2, …) for each damaged object 12.

When the damaged object 12 is an original-form object, the scattering speed V may be defined as a composite vector of a movement speed vector of the enemy aircraft 6 and a movement speed vector of the missile 5 (a direction in which damage is received; the vector may be appropriately multiplied depending on the capability of the missile 5).

When the damaged object 12 is a partial object, the scattering speed V may be defined as a composite vector of the movement speed vector of the enemy aircraft 6, the movement speed vector of the missile 5, and a dispersion vector generated at random.

Regardless of whether the damaged object 12 is the original-form object or the partial object, the damaged object 12 is moved along a given direction based on the direction from which the enemy aircraft 6 (the object that is the source of the damaged object 12) received the damage that caused the damaged object 12 to be generated.

Next, the server system 1100 determines a trajectory (falling course) along which the damaged object 12 falls, using the scattering speed V as an initial speed vector. The trajectory is applied by selecting one of a plurality of trajectory types prepared in advance. Examples of trajectory types may include: (1) a simple parabolic curve; (2) a composite random curve that is overall parabolic but involves random changes in direction and acceleration/deceleration, like a falling leaf; and (3) a corkscrew curve that is overall parabolic but involves falling while spiraling. Of course, trajectory types other than these may be appropriately set depending on the design of the enemy aircraft 6 and the settings of the game world. Alternatively, instead of selecting the trajectory from trajectory types prepared in advance, the trajectory may be determined on a case-by-case basis by physical calculation.

Which trajectory type is to be selected is determined according to a predetermined rule based on the size and weight of the damaged object 12. Part categories (for example, wing portions, unused weapons, a fuselage, an engine, a canopy, small components, and the like) may be set for respective parts of the enemy aircraft 6, and the trajectory type may be selected according to a predetermined rule with reference to the part categories of the parts constituting the damaged object 12. Of course, a trajectory type that the game creator considers appropriate may be specified in advance for each part, and the trajectory type specified for the uppermost hierarchical part among the parts constituting the damaged object 12 may be adopted.

Therefore, the damaged objects 12 of the enemy aircraft 6 are set in a diverse manner such that, depending on what type of enemy aircraft 6 is shot down, in what kind of crushing it is, and what type of missile 5 it is hit by and in what manner, it is determined whether the enemy aircraft 6 falls while maintaining its original form or is decomposed and scattered, and what speed is given during the falling.

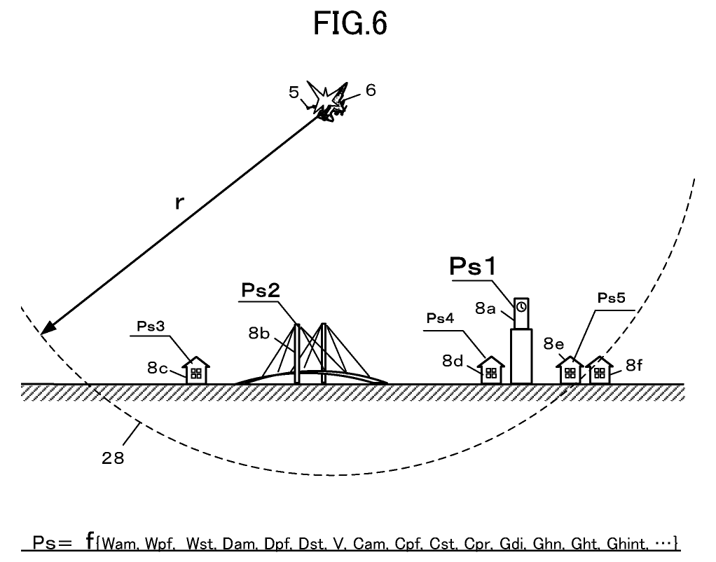

FIG. 6 is a diagram for describing the setting of a specific parameter value related to the selection of the movement-target object 20, which is one of the factors that influence the mode of “collateral destruction.”

Specific parameter values Ps (Ps1, Ps2, …) are set for each ground object 8 (candidate object) that is a candidate for the movement-target object 20 for the damaged object 12.

The candidate objects (ground objects 8 serving as candidates) for the movement-target object 20 are the ground objects 8 that are present within a candidate selection range 28 with reference to an initial position (for example, a position at which the missile 5 hits the enemy aircraft 6) of the damaged object 12. The candidate selection range 28 may be, for example, a spherical or approximately spherical range having a radius r (this radius is determined by, for example, a predetermined function according to the flight altitude of the enemy aircraft 6 in the game space 3). Alternatively, the candidate selection range 28 may have a conical shape expanding along a direction of the scattering speed V of the damaged object 12 as its axis.

The specific parameter value Ps is obtained by using a function f that uses various parameter values as variables. In FIG. 6, differences in magnitude among the specific parameter values Ps obtained for the respective candidate objects are represented by differences in font size.

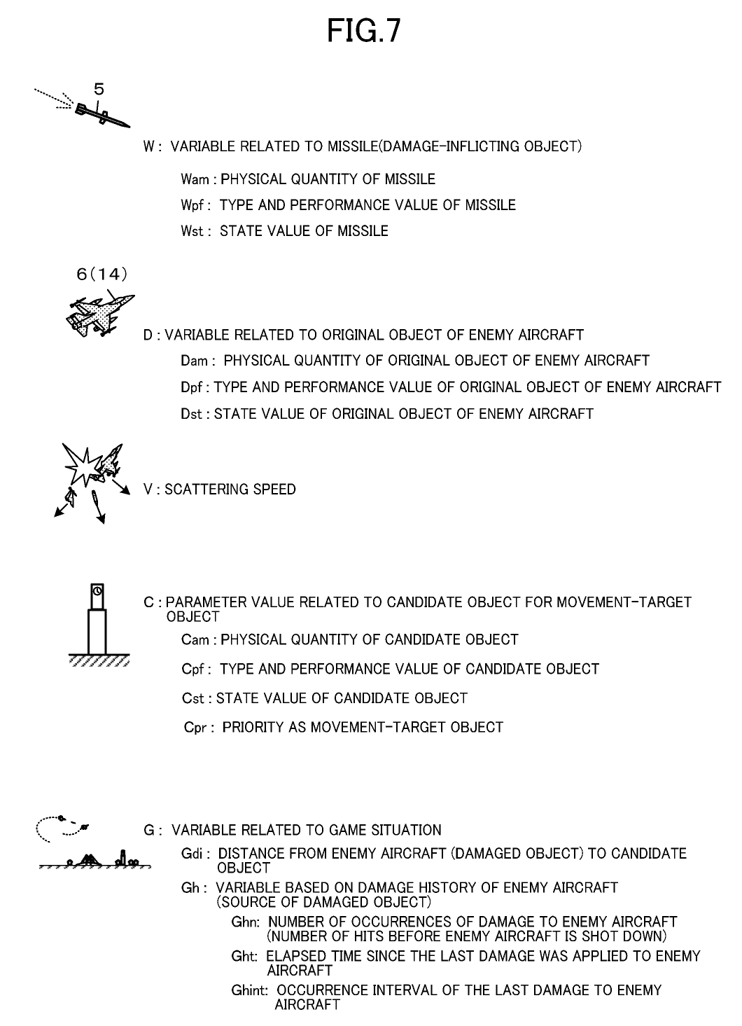

As shown in FIG. 6, the function f for calculating the specific parameter value Ps is defined using a plurality of variables. As these variables, for example, one or more of the following five parameter values shown in FIG. 7 may be appropriately used.

(1) Variables W (Wam, Wpf, Wst) related to the missile 5

Wam: a physical quantity of the missile 5 in the game (for example, size, weight, etc.)

Wpf: a value indicating the type of the missile 5, or a performance value in the game (for example, power, effective range, etc.)

Wst: a state value of the missile 5 (for example, movement speed, etc.)

The physical quantity Wam is defined by the function f such that the specific parameter value Ps increases as the value of Wam increases. The value Wpf is defined by the function f such that the specific parameter value Ps increases when a value indicating the type (with higher values assigned to aircraft types having higher performance) is high or when it is a value indicating a type having a higher performance value. The state value Wst is defined by the function f such that the specific parameter value Ps increases as an energy value of the missile 5 increases. That is, the state value Wst is defined by the function f such that the specific parameter value Ps increases as the missile 5 has higher destructive power. Note that the variables W (Wam, Wpf, Wst) are variables related to a damage-inflicting object (the missile 5) that has inflicted damage on the enemy aircraft 6; however, the variables are not limited to those related to the missile 5, and may alternatively be physical quantities, types, performance, or states of the player aircraft 4.

(2) Variables D (Dam, Dpf, Dst) related to the original object 14 of the enemy aircraft 6 (see FIG. 5)

Dam: a physical quantity of the enemy aircraft 6 in the game (for example, size, weight, etc.)

Dpf: a value indicating the type of the enemy aircraft 6, or a performance value in the game (for example, maximum speed, maximum altitude, number of mounted weapons, etc.)

Dst: a state value of the enemy aircraft 6 (for example, remaining hit point, remaining ammunition quantity, types of unused weapons, etc.)

The physical quantity Dam is defined by the function f such that the specific parameter value Ps increases as the value of Dam increases. The value Dpf is defined by the function f such that the specific parameter value Ps increases when the value indicating the type is high, or when it is a value indicating a type having a higher performance value. The state value Dst is defined by the function f such that the specific parameter value Ps increases as an energy value increases. That is, the function f is defined such that the specific parameter value Ps increases as the enemy aircraft 6 is capable of causing greater damage upon crashing.

(3) Scattering speed V of the damaged object 12

The scattering speed V is defined by the function f such that the specific parameter value Ps increases as the speed increases.

(4) Variables C (Cam, Cpf, Cst, Cpr) related to ground objects 8 that are candidates for the movement-target object 20

Cam: a physical quantity of the candidate object in the game (for example, size, weight, etc.)

Cpf: a value indicating the type of the candidate object, or a performance value in the game

Cst: a state value of the candidate object (for example, accumulated damage value, etc.)

Cpr: a priority for selecting the candidate object as the movement-target object 20

The physical quantity Cam and the performance value Cpf are defined by the function f such that the specific parameter value Ps increases as the values of the physical quantity Cam or the performance value st increases. For example, the specific parameter value Ps increases for a ground object 8 that appears to have a greater impact on its surroundings so that complete destruction is presented in more conspicuous manner. Further, the priority Cpr is defined by the function f such that the specific parameter value Ps increases as the value indicates a higher priority.

The priority Cpr is set by the game creator in an order based on how strong the visual effect of damage display is expected to be when the corresponding ground object 8 undergoes “collateral destruction.” In the present embodiment, the clock tower 8a is set to the first priority, the bridge 8b is set to the second priority, and the general buildings 8c to 8f are set to the third priority (lowest priority).

The clock tower 8a is the tallest building, is located on the advance route of enemy ground forces, and is positioned in the vicinity of the general buildings 8d to 8f. Assuming a case where the clock tower 8a is completely destroyed, the clock tower 8a is set to the first priority because (1) the advance route of the enemy ground forces becomes impassable, thereby giving the player a tactical advantage, (2) a high visual effect is obtained due to the destruction of the tallest building, and (3) a sense of tension due to further involvement of the general buildings 8d to 8f in the destruction can be secondarily produced. Note that, as the lowest priority, a predetermined value indicating that the candidate object cannot be selected as the movement-target object 20 may be set.

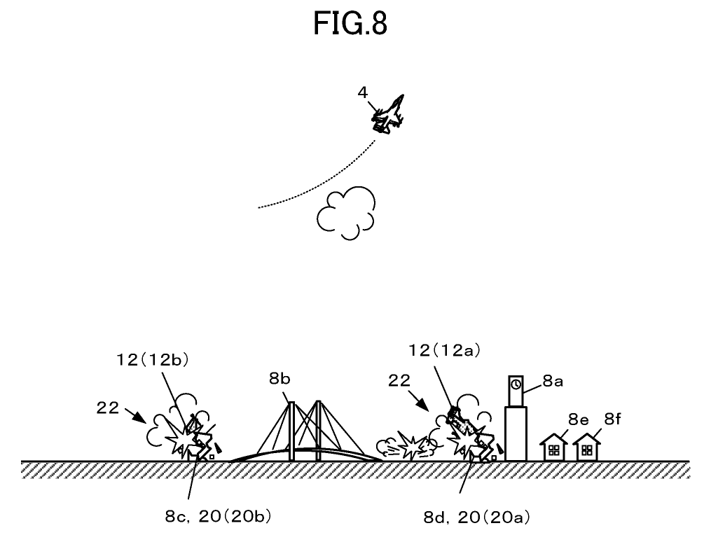

In the absence of a priority, as illustrated in the example shown in FIG. 8, the general buildings 8c to 8f are more likely to be selected as the movement-target objects 20. In the example of FIG. 8, the general building 8d is selected as the movement-target object 20a corresponding to the damaged body 12a, and the general building 8c is selected as the movement-target object 20b corresponding to the left-wing portion 12b, and both of them are completely destroyed.

However, when FIG. 8 and FIG. 4 are compared with attention paid to the visual impression as a damage display, it is obvious at a glance which provides a stronger visual impression and greater impact. As described later, the collateral damage display 22, that is, the “collateral destruction,” does not necessarily occur in every case. Therefore, from the viewpoint of enhancing the sense of entertainment, it is beneficial, in terms of how the collateral damage display 22 is enabled, to set a priority so as to increase the likelihood that an example such as that shown in FIG. 4 will occur.

Further, when attention is paid to changes in the game situation caused by the “collateral destruction,” complete destruction of the clock tower 8a and the bridge 8b cuts off the advance routes of enemy ground forces. As a result, the player can, for example, prevent enemy anti-aircraft vehicles from approaching. From the player’s perspective, a case in which the clock tower 8a and the bridge 8b undergo collateral destruction as in the example of FIG. 4 allows the game to be progressed more advantageously than the case shown in FIG. 8. Once the player becomes aware of such an advantage, the player begins to attempt tactical play, such as making use of the “collateral destruction” to shoot down the enemy aircraft 6 in the vicinity above the ground object 8 that is likely to serve as a key point. This further enhances the sense of entertainment of the game.

If the ground object 8 is, for example, an enemy air-defense radar facility, an air traffic control tower of an enemy airport, an enemy communication tower, an entrance or exit of an underwater tunnel, or a railway, it is preferable to set a relatively high priority as in the case of the clock tower 8a or the bridge 8b since a similar effect of providing an advantage to the player can be obtained.

Further, depending on the configuration of the game stage, maritime objects may be placed instead of the ground objects 8 or in combination with the ground objects 8. In such a case, a relatively high priority is set for an enemy aircraft carrier, an enemy supply ship, an enemy destroyer, an offshore plant, a submarine, and the like, as in the case of the clock tower 8a or the bridge 8b. On the other hand, by setting a relatively low priority for a civilian vessel, a hospital ship, a lighthouse, an offshore wind power generation facility, and the like as in the case of the general buildings 8c to 8f, effects related to visual impression and effects of providing an advantage to the player can be appropriately obtained.

Referring back to FIG. 7,

(5) Variables G (Gdi, Ghn, Ght, Ghint) related to the game situation

Gdi: a distance from the enemy aircraft 6 (or the damaged object 12) to the candidate object

Ghn: the number of damage occurrences (number of hits) applied to the enemy aircraft 6 (or to the object that is the source of the damaged object 12)

Ght: an elapsed time since the last damage was applied to the enemy aircraft 6

Ghint: an interval at which damage is applied to the enemy aircraft 6 (for example, an average value of damage occurrence intervals over the past N occurrences)

The number of damage occurrences Ghn, the elapsed time Ght, and the damage occurrence interval Ghint can be regarded as variables based on the history of damage applied to the enemy aircraft 6, more specifically, the history of damage applied to the object that is the source of the damaged object 12.

The distance Gdi is defined by the function f such that the specific parameter value Ps increases as the value of the distance Gdi decreases. The number of damage occurrences Ghn is defined by the function f such that the specific parameter value Ps increases as the number of damage occurrences Ghn increases. The elapsed time Ght is defined by the function f such that the specific parameter value Ps increases as the value of the elapsed time Ght decreases. The damage occurrence interval Ghint is defined by the function f such that the specific parameter value Ps increases as the value of the damage occurrence interval Ghint decreases.

By appropriately setting the number of damage occurrences Ghn, the elapsed time Ght, and the damage occurrence interval Ghint, it is possible to detect an attack rush equivalent to a so-called “combo,” in which a large number of attacks are successively hit on the enemy aircraft 6 within a short period of time without the player aircraft 4 receiving damage. When such a “combo”-equivalent attack rush is detected, the specific parameter value Ps may be calculated to be larger.

Referring back to FIG. 6, the server system 1100 selects and sets, as the movement-target object 20 corresponding to the damaged object 12, a predetermined number (at least one) of the candidate objects in descending order, starting from the candidate object having the largest specific parameter value Ps.

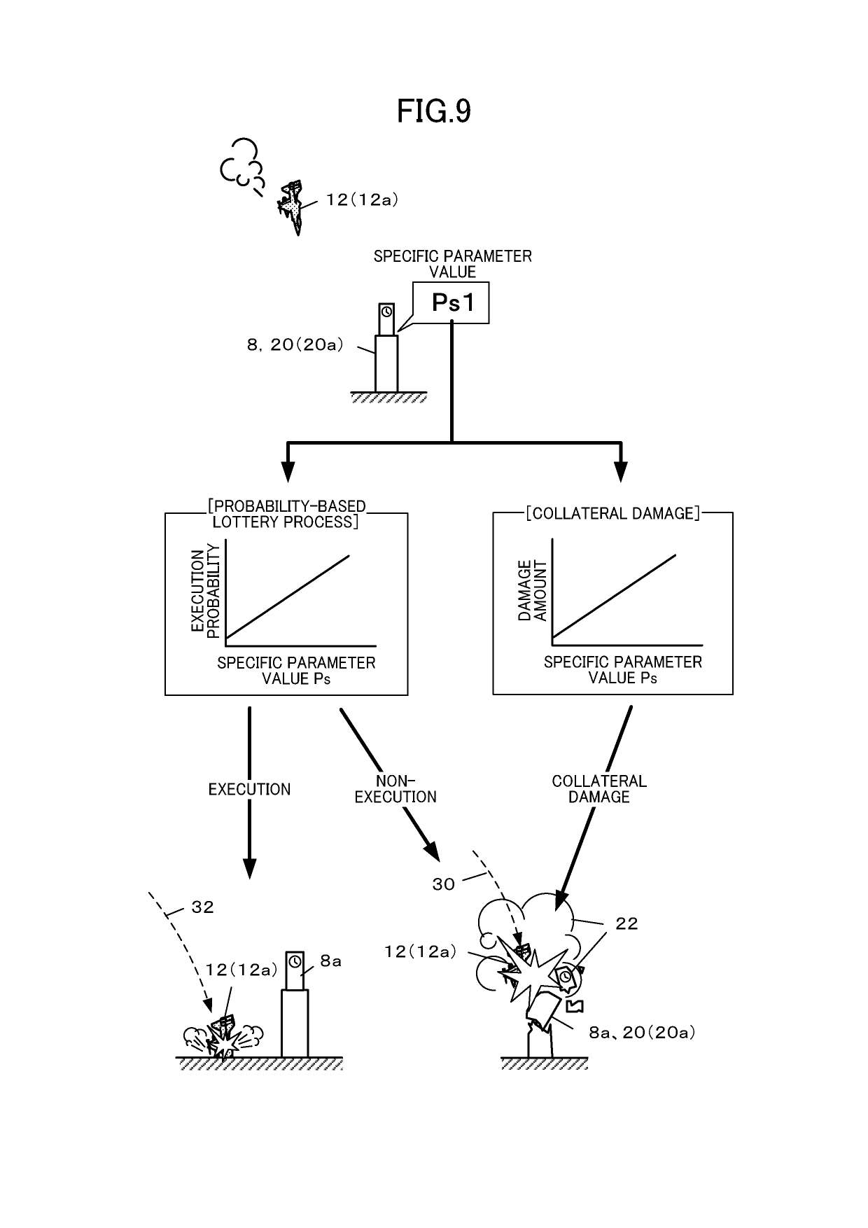

FIG. 9 is a diagram for describing control of “collateral destruction” based on the specific parameter value Ps. The server system 1100 determines, based on the specific parameter value Ps of the movement-target object 20, an execution probability of the “collateral destruction (impact display control)” and an execution probability of the collateral damage display 22. For example, these execution probabilities are determined such that each probability increases as the specific parameter value Ps increases.

The server system 1100 executes a probability-based lottery process using the execution probability. When the probability-based lottery yields a positive result, a collision trajectory 30 for causing collision or contact with the corresponding movement-target object 20 is set for the damaged object 12. Then, the movement of the damaged object 12 is controlled so that the damaged object 12 moves toward the corresponding movement-target object 20 along the set collision trajectory 30.

The collision trajectory 30 is not limited to a course in which the damaged object 12 collides with or comes into contact with the movement-target object 20, and may alternatively be a trajectory that allows a deviation within a range in which collision determination is made. Further, the collision trajectory 30 may be a course that falls to a position in close proximity, due to the impacts associated with the fall of the damaged object 12.

Specifically, a parabolic motion trajectory serving as a base of the collision trajectory 30 may be generated first, and the collision trajectory 30 may be determined by arranging the parabolic motion trajectory into a trajectory form corresponding to the trajectory type (for example, those indicated by the three types of broken-line arrows in FIG. 3). For example, the collision trajectory 30 may be determined by performing arrangement such as enlargement/reduction and deformation such that a start point, an intermediate point, and an end point of a curve function prepared in advance for each trajectory type are aligned with a start point, an intermediate point, and an end point of the parabolic motion trajectory serving as the base.

When the damaged object 12, which is controlled in its movement based on the collision trajectory 30, eventually collides with, comes into contact with, or approaches the corresponding movement-target object 20, the server system 1100 determines that a given positional relationship condition is satisfied and applies collateral damage to the movement-target object 20.

The “collateral damage amount” increases as the specific parameter value Ps increases. Then, impact application control corresponding to the accumulated collateral damage amount is performed on the movement-target object 20, and the collateral damage display 22 is displayed. For example, when the accumulated collateral damage amount exceeds a predetermined durability value set for the movement-target object 20, a collateral damage display 22 representing complete destruction of the movement-target object 20 is displayed. In other words, “collateral destruction” is expressed.

If the probability-based lottery process using the execution probability does not yield a positive result, a non-collision trajectory 32 is set in which the damaged object 12 falls toward the corresponding movement-target object 20 without colliding with the movement-target object 20. The damaged object 12 is then controlled in its movement based on the non-collision trajectory 32. The non-collision trajectory 32 can be set in a manner similar to that used to create the collision trajectory 30.

The damaged object 12 that is controlled in its movement based on the non-collision trajectory 32 eventually falls to the ground without colliding with the corresponding movement-target object 20, and thus does not inflict damage on the movement-target object 20. In the examples shown in FIGS. 3 and 4, this corresponds to a case in which the unused weapon 12c falls to the ground but does not cause damage to either the bridge 8b or the general building 8d.

In other words, the specific parameter value Ps set for the movement-target object 20 can be regarded as corresponding to a “degree of attraction” at which the damaged object 12 is drawn toward the movement-target object 20 as it falls. Further, when the damaged object 12 collides with the corresponding movement-target object 20, the specific parameter value Ps can be regarded as corresponding to a degree of damage.

Further, when attention is paid to the damaged movement control of the damaged object 12, the collision trajectory 30 and the non-collision trajectory 32 are determined by (1) the direction of gravity in the gravity field, and (2) the relative positional relationship between the damaged object 12 and the corresponding movement-target object 20. The corresponding movement-target object 20 is determined based on the specific parameter value Ps of the damaged object 12. Accordingly, it can also be regarded that the movement of the damaged object 12 is controlled based on the specific parameter value Ps.

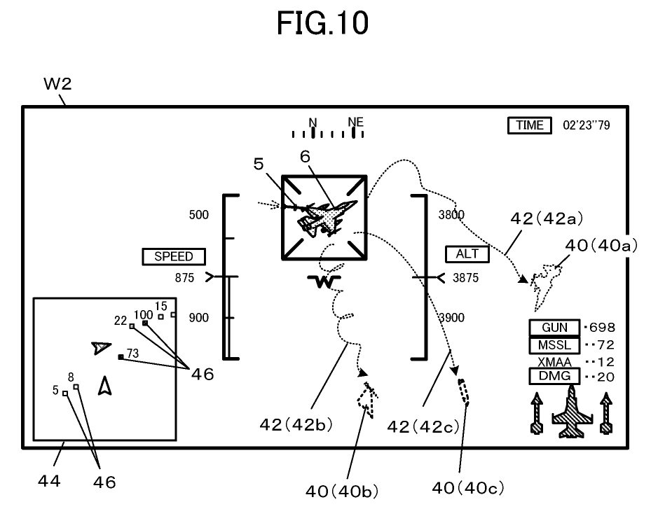

FIG. 10 is a diagram showing a display example of a game screen, and illustrates a display example of a measuring-instrument-display type. In this game screen of a measuring-instrument-display type, various types of measurement instrument information (for example, a compass, an altimeter, a speedometer, remaining ammunition quantity, remaining hit points, a radar screen, etc.) are displayed over an image of the game space 3 captured by a forward-facing virtual camera set on the player aircraft 4. The game screen display is not limited to this example, and may alternatively be a cockpit-view type or a third-person-view type. The cockpit-view type refers to a view captured by a pilot-viewpoint virtual camera disposed inside the cockpit of the player aircraft 4. The third-person-view type refers to a view captured by a third-person-viewpoint virtual camera that is disposed to follow the player aircraft 4 from behind.

In a game screen W2, when the missile 5 hits the enemy aircraft 6, silhouettes 40 (40a, 40b, 40c) of the respective damaged objects 12 and prediction displays 42 (42a, 42b, 42c) for the damaged movement control are displayed for a predetermined period of time.

The silhouettes 40 are displayed while moving along the trajectories of the damaged objects 12.

The prediction displays 42 serve to predict the trajectory along which the damaged object 12 moves. Specifically, in the prediction displays 42, the collision trajectory 30 or the non-collision trajectory 32 is displayed, for example, in the form of a line. The line type and display color vary depending on the magnitude of the specific parameter value Ps of the damaged object 12. The form of the prediction display 42 for the collision trajectory 30 may be made different from that for the non-collision trajectory 32.

In the prediction displays 42, the trajectory (predicted course) is not necessarily represented in the form of a line, and may instead be indicated as a movement direction. Specifically, the silhouettes 40 may be displayed while moving, and a speed vector at each moment may be displayed as an arrow. Further, a line representing the trajectory may be displayed after the movement of each silhouette 40, so that both the direction and the trajectory are provided as the prediction displays 42.

On the radar screen 44, marks 46 representing the ground objects 8 are displayed, and these marks 46 are displayed in the form of identifiable display according to the specific parameter values Ps corresponding to the respective ground objects 8. For example, the marks 46 are displayed in the form of identifiable display using different display colors corresponding to the specific parameter values Ps. In the example of FIG. 10, differences are shown by using a white mark 46 and a hatched mark 46. Further, the display may be performed using a specific color for a mark 46 of the ground object 8 selected as the movement-target object 20. In the example of FIG. 10, the mark 46 filled in black corresponds to this case. In addition, the specific parameter value Ps may be displayed not only by using variable display colors for the marks 46 but also by attaching numerical texts (numerals displayed in the radar screen 44). The identifiable display may also be performed by varying the shapes of the marks 46 of the ground objects 8.

By means of the prediction displays 42, the player can grasp at a glance the direction in which the debris of the enemy aircraft 6, which has been hit by the missile 5, will scatter and whether the debris will cause the collateral destruction as it falls. At that time, by referring to the installation positional relationship of the marks 46 on the radar screen 44, the player is provided with clues for acquiring tactics, such as determining in what positional relationship relative to the ground objects 8 the enemy aircraft 6 should be shot down to cause collateral destruction, and what range of ground objects 8 is affected by the collateral destruction. Once such tactics are acquired, the player can control the position and timing at which the enemy aircraft 6 is shot down and make use of the collateral destruction to continue the gameplay in an advantageous manner. This provides a novel sense of entertainment and enhances the appeal of the gameplay.

Next, a functional configuration will be described.

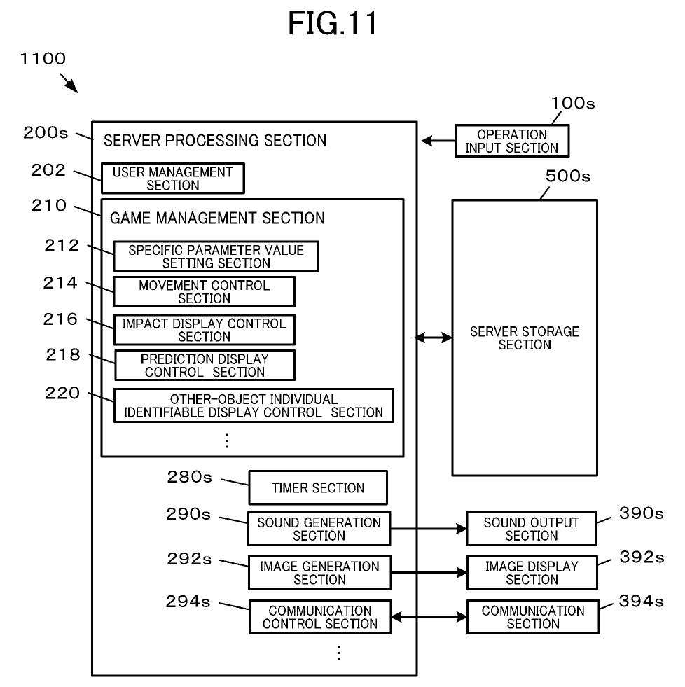

FIG. 11 is a block diagram illustrating a functional configuration example of the server system 1100.

The server system 1100 includes an operation input section 100s, a server processing section 200s, a sound output section 390s, an image display section 392s, a communication section 394s, and a server storage section 500s.

The operation input section 100s is a means for inputting various operations for the management of the server system 1100. For example, the operation input section 100s is a keyboard, a touch panel, a mouse, or the like.

The server processing section 200s is implemented, for example, by a processor that is a calculation circuit such as a CPU, a GPU, an ASIC, or an FPGA and an electronic component such as an IC memory. The server processing section 200s performs input/output control of data to/from functional sections including the operation input section 100s and the server storage section 500s. The server processing section 200s performs various calculation processes based on predetermined programs and data, and data of operation input signals from the operation input section 100s, or the like to comprehensively control the server system 1100.

The server processing section 200s has a user management section 202, a game management section 210, a timer section 280s, a sound generation section 290s, an image generation section 292s, and a communication control section 294s.

The user management section 202 performs a process related to a user registration procedure of the game system 1000, and stores and manages various types of information associated with a user account.

The game management section 210 performs various types of control related to game execution. Specifically, the game management section 210 sets a game space by arranging background objects in a virtual three-dimensional space, also arranges objects including the player aircraft 4, the enemy aircraft 6, and the ground objects 8 in the game space, and controls the player aircraft 4 in accordance with operation inputs from the player. In addition, the game management section 210 automatically controls the operations of the missiles 5 and the enemy aircraft 6. Further, the game management section 210 performs hit determination between objects, determination of play results, and the like.

The game management section 210 includes a specific parameter value setting section 212, a movement control section 214, an impact display control section 216, a prediction display control section 218, and an other-object individual identifiable display control section 220.

The specific parameter value setting section 212 sets the specific parameter value Ps that is referenced during the movement control of the damaged object 12 that moves upon receiving damage.

Specifically, the specific parameter value setting section 212 sets the specific parameter value Ps based on at least one of the type, the physical quantity, the performance, and the state of the original object 14 of the enemy aircraft 6 (see FIG. 7; various types of the variable D).

Further, the specific parameter value setting section 212 sets the specific parameter value Ps corresponding to each ground object 8 serving as a candidate for the movement-target object 20 based on at least one of the priority, the type, the physical quantity, the performance, and the state of the ground object 8 as the candidate (see FIG. 7; various types of the variable C).

Further, the specific parameter value setting section 212 sets the specific parameter value Ps based on at least one of the type, the physical quantity, the performance, and the state of a damage-inflicting object that has inflicted the damage (see FIG. 7; various types of the variable W).

Further, the specific parameter value setting section 212 sets the specific parameter value Ps based on a game situation, which is defined by at least one of: (1) a distance between the damaged object 12 and the ground object 8 serving as a candidate for the movement-target object 20, (2) a damage history of the damaged object 12, (3) a number of damage occurrences, (4) an interval of damage occurrences, and (5) an elapsed time since the last occurrence of damage (see FIG. 7; various types of the variable G).

The movement control section 214 performs movement control (damaged movement control) of the damaged object 12 with reference to the specific parameter value Ps. Specifically, a predetermined gravity field is provided in the game space 3, and the collision trajectory 30 or the non-collision trajectory 32 directed to fall in a gravity direction based on the gravity field is set. Then, the damaged object 12 is gradually moved based on the course indicated by the set trajectory. This corresponds to the damaged movement control (see FIG. 9).

When attention is paid on the setting and application of the collision trajectory 30, the movement control section 214 selects, using the specific parameter values Ps respectively corresponding to the candidate objects for the movement-target object 20, the movement-target object 20 in the damaged movement control of the damaged object 12. It can therefore be said that the movement control section 214 performs control to move the damaged object 12 toward the selected movement-target object 20.

Further, the movement control section 214 sets the scattering speed V as an initial speed for movement control of the damaged object 12 (see FIG. 5). Since the scattering speed V reflects the result of determination of the direction in which the missile 5 hit the enemy aircraft 6, it can be regarded that the movement control section 214 performs control to move the damaged object 12 along a given direction based on the direction in which the enemy aircraft 6 received the damage.

The impact display control section 216 performs control of impact display that indicates reception of impact by other object when a given positional relationship condition is satisfied. The positional relationship condition is based on approach or contact of the other object and the damaged object 12 due to the damaged movement control. This corresponds to the display control of the collateral damage display 22 related to the ground object 8 (see FIG. 4).

Specifically, the impact display control section 216 performs impact display control for an object that satisfies the positional relationship condition from among a plurality of the ground objects 8 (other object) present in the game space.

Further, the impact display control section 216 controls whether or not to perform the impact display control by using the specific parameter value Ps. This corresponds to the probability-based lottery process for determining whether a collision between the damaged object 12 and the movement-target object 20 is to be executed (see FIG. 9).

The prediction display control section 218 controls the display of the prediction displays 42 that indicate a direction and/or a trajectory along which the damaged object 12 moves in a variable manner (see FIG. 10).

The other-object individual identifiable display control section 220 performs identifiable display for each ground object 8 based on the specific parameter value Ps corresponding to the object. This corresponds to the identifiable display of the marks 46 on the radar screen 44 (see FIG. 10).

The timer section 280s uses a system clock to measure various times such as the current date and time and limited time periods.

The sound generation section 290s is implemented by executing an IC or software that generates and decodes sound data. The sound generation section 290s outputs generated sound signals to the sound output section 390s. The sound output section 390s is implemented by a speaker or the like, and emits sounds based on the sound signals.

The image generation section 292s generates images of various management screens for the system management of the server system 1100, and outputs image data to the image display section 392s. The image generation section 292s also generates some or all of the images to be displayed on the user terminal 1500. The image display section 392s is implemented by a device for displaying images such as a flat panel display, a head-mounted display, or a projector.

The communication control section 294s performs data processing related to data communication, and implements data exchange with an external device through the communication section 394s. The communication section 394s connects to the network 9 to implement communication. For example, the communication section 394s is implemented by a wireless communication device, a line terminating device, a modem, a terminal adaptor (TA), a jack for wired communication cable, a control circuit, or the like. In the example of FIG. 1, the communication device 1153 corresponds to the communication section 394s.

The server storage section 500s stores programs, various types of data, etc. for implementing various functions for causing the server processing section 200s to comprehensively control the server system 1100. The server storage section 500s is used as a work area for the server processing section 200s, and temporarily stores results of calculations executed by the server processing section 200s in accordance with the various types of programs. These functions are implemented, for example, by an IC memory such as a RAM or a ROM, a magnetic disk such as a hard disk, an optical disk such as a CD-ROM or a DVD, or an online storage. In the example of FIG. 1, storage media such as the IC memory 1152 mounted in the server system 1100 and hard disks correspond to the server storage section 500s.

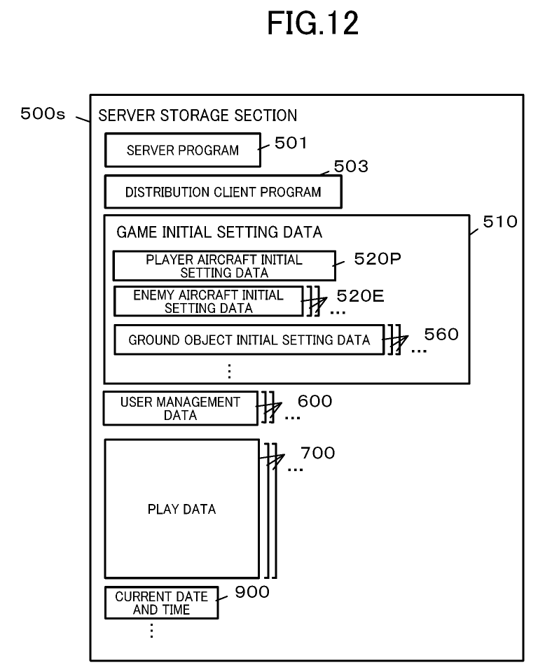

FIG. 12 is a diagram illustrating an example of the programs and data stored in the server storage section 500s.

The server storage section 500s stores a server program 501 and a distribution client program 503. The server storage section 500s also stores game initial setting data 510, user registration data 600 that manages various types of data related to registered users for each user, play data 700, and current date and time 900. The server storage section 500s also stores other programs and data (e.g., a timer, a counter, and various flags) as appropriate.

The server program 501 is a program for implementing functions of the user management section 202 and the game management section 210.

The distribution client program 503 is an original client program provided to the user terminal 1500 and executed therein.

The game initial setting data 510 stores various types of initial setting data related to the game. The game initial setting data 510 includes player aircraft initial setting data 520P, enemy aircraft initial setting data 520E, and ground object initial setting data 560. Other types of data may be included as appropriate, of course.

The player aircraft initial setting data 520P stores various initial setting values of the player aircraft 4. The enemy aircraft initial setting data 520E is prepared for each type of the enemy aircraft 6 appearing in the game and stores various initial setting values of the enemy aircraft 6.

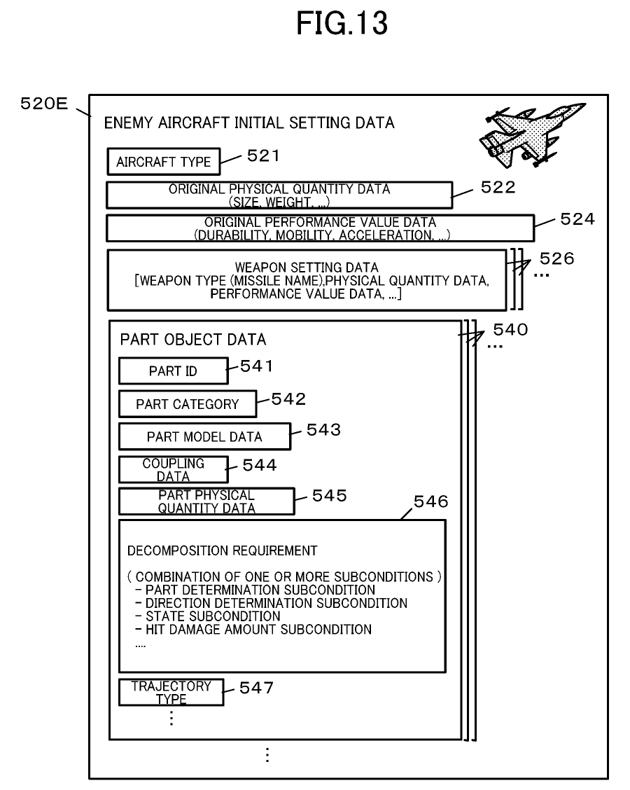

The player aircraft initial setting data 520P and the enemy aircraft initial setting data 520E differ in their setting targets but basically have the same data configuration. Taking the enemy aircraft initial setting data 520E as an example, as shown in FIG. 13, the data includes, for example, an aircraft type 521, original physical quantity data 522, original performance value data 524, weapon setting data 526, and part object data 540.

The weapon setting data 526 is prepared for each type of armament, such as the missiles 5 and auxiliary fuel tanks, mounted on the enemy aircraft 6. Each piece of the weapon setting data 526 includes a weapon type, physical quantity data, and performance value data.

The part object data 540 is prepared for each of various part objects constituting the original object 14, and includes various types of data related to these parts.

One piece of the part object data 540 includes, for example, a part ID 541, a part category 542, part model data 543, coupling data 544, part physical quantity data 545, a decomposition requirement 546, and a trajectory type 547.

The coupling data 544 stores, for example, a part ID of an upper hierarchical part (parent part) to which the corresponding part is coupled, coupling position information, and the like.

The decomposition requirement 546 defines conditions that must be satisfied for the corresponding part to be decomposed from the upper hierarchical part. The decomposition requirement 546 is defined using at least one of a part determination subcondition, a direction determination subcondition, a state subcondition related to a state parameter value of the airframe, and a hit damage amount subcondition related to a hit damage amount that is given upon receiving an attack.

The number and contents of the subconditions that describe the decomposition requirement 546 are not limited to those described above and may be set as appropriate. For example, the decomposition requirement 546 may additionally include, as appropriate, a subcondition related to the type of a missile that has hit, a subcondition related to a damage amount given by the hit of the missile 5, and a subcondition related to the number of the missiles 5 that have hit the enemy aircraft 6 until the enemy aircraft 6 is shot down.

The trajectory type 547 specifies the type of falling course to be applied when the corresponding part is decomposed from the parent part and becomes the damaged object 12, and the damaged movement control is performed.

If none of these items of the decomposition requirement 546 is satisfied, the enemy aircraft 6 falls as a single damaged object 12 (12g; see FIG. 5) in the form of an original-form object. If one or more of these items of the decomposition requirement 546 are satisfied, the enemy aircraft 6 is divided into a plurality of partial objects, each of which becomes the damaged object 12 (12a, 12b, 12c; see FIG. 5).

Note that, when an allied NPC aircraft of the player aircraft 4 appears in the game, player aircraft initial setting data 520P for the corresponding allied aircraft is separately prepared.

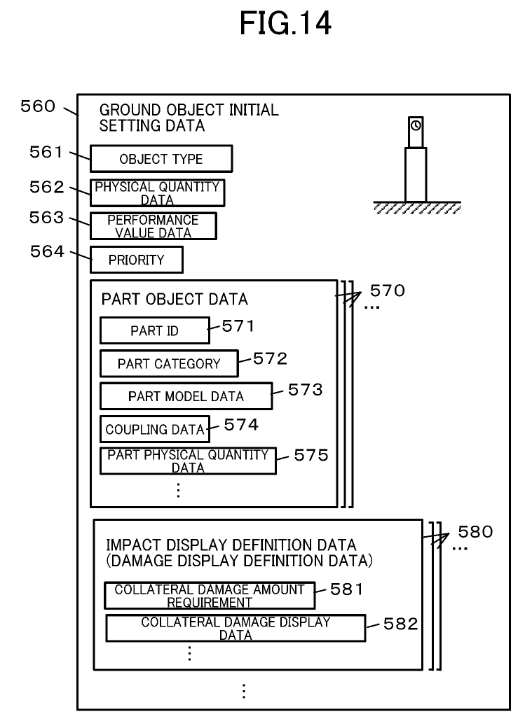

The ground object initial setting data 560 is prepared for each type of the ground object 8, and stores various types of data related to the ground object 8 of the corresponding type. As shown in FIG. 14, one piece of the ground object initial setting data 560 includes, for example, an object type 561, physical quantity data 562, performance value data 563, a priority 564, part object data 570, and impact display definition data 580. Other types of data may be included in the ground object initial setting data 560 as appropriate, of course.

The part object data 570 is prepared for each of various part objects constituting the corresponding ground object 8, and includes various types of data related to the corresponding part. One piece of the part object data 570 includes a part ID 571, a part category 572, part model data 573, coupling data 574, and part physical quantity data 575.

The parts of the ground object 8 defined by the part object data 570 are respective portions of the ground object 8 in a destroyed state represented as the collateral damage display 22. Accordingly, when the collateral damage display 22 is expressed as disappearance, the part object data 570 may be omitted.

The impact display definition data 580 is prepared for each type of the collateral damage display 22 for the ground object 8 of the corresponding type. One piece of the impact display definition data 580 includes a collateral damage amount requirement 581 and collateral damage display data 582.

The collateral damage amount requirement 581 indicates a condition regarding a collateral damage amount that must be satisfied for the corresponding setting data to be applied.

The collateral damage display data 582 is used for executing the collateral damage display 22. For example, the damage display data 582 corresponding to the collateral damage amount requirement 581 defined as a requirement in which the collateral damage amount is relatively small may serve as dust-cloud effect data representing the occurrence of a collision. When the impact display is executed, the corresponding effect is displayed.

Further, the damage display data 582 corresponding to the collateral damage amount requirement 581 defined as a requirement in which the collateral damage amount is relatively large specifies which part object constituting the ground object 8 is to be decomposed. Further, the damage display data 582 may further include, as appropriate, explosion-smoke effects, flash effects, and the like, for expressing the intensity of the impact. When the impact display is executed based on the corresponding definition data, explosion-smoke effects and flash effects are executed, and the ground object 8 is decomposed into parts, which are then, for example, controlled in their movement in accordance with the gravity field.

Referring back to FIG. 12, the play data 700 is created for each game play. The play data 700 includes various types of data related to game progression control for the corresponding game play.

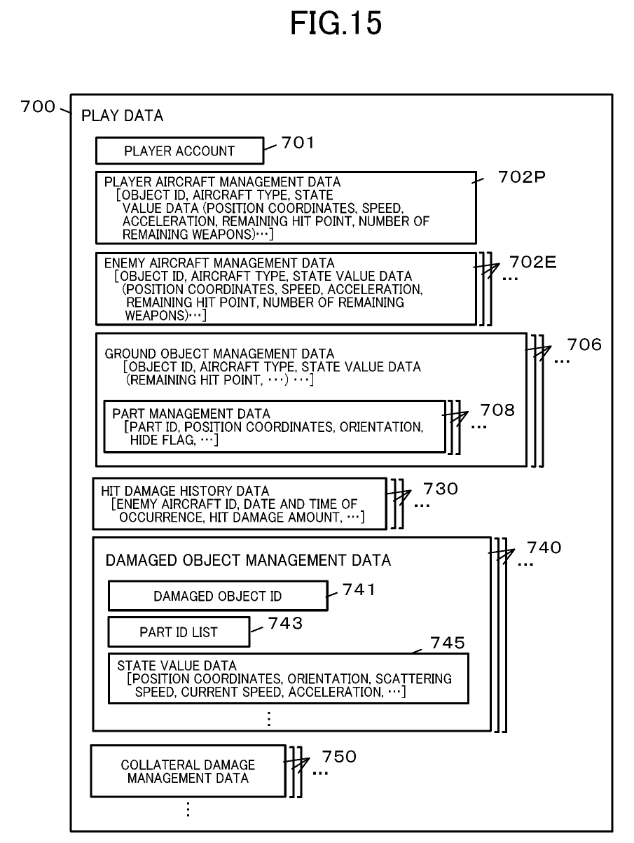

One piece of the play data 700 includes, for example, as shown in FIG. 15, a player account 701, player aircraft management data 702P, enemy aircraft management data 702E, and ground object management data 706. Further, each of the play data 700 further includes hit damage history data 730, damaged object management data 740, and collateral damage management data 750. Other types of data may be included in the play data 700 as appropriate, of course.

The player aircraft management data 702P stores various types of latest data for controlling the player aircraft 4. For example, the player aircraft management data 702P includes an object ID, an aircraft type, and state value data. Other types of data may also be stored in the player aircraft management data 702P as appropriate, of course. The state value data includes, for example, position coordinates, speed, acceleration, remaining hit point (or accumulated damage value), and a remaining number of weapons.

The enemy aircraft management data 702E is created for each enemy aircraft 6, and stores the various types of latest data for controlling the corresponding enemy aircraft 6. The data configuration of the enemy aircraft management data 702E is the same as that of the player aircraft management data 702P.

The ground object management data 706 is created for each ground object 8, and stores the various types of latest data for controlling the corresponding ground object 8. The ground object management data 706 stores, for example, an object ID, position coordinates, state value data (such as remaining hit points or accumulated damage values), and part management data 708.

The part management data 708 is prepared for each part of the ground object 8, and stores information regarding the position and orientation of the part. In an initial state at the start of the game, each part of the ground object 8 is located at an initial position and in an initial orientation indicated by the ground object initial setting data 560, and the ground object 8 is displayed in an undamaged state.

When the ground object 8 is involved in the fall of the damaged object 12 and receives collateral damage, the parts specified by the damage display data 582 (see FIG. 14) depart from their initial positions and initial orientation, thereby executing the collateral damage display 22 such as partial destruction or complete destruction.

The hit damage history data 730 is created each time an attack by the missile 5 of the player aircraft 4 hits the enemy aircraft 6. One piece of the hit damage history data 730 stores an enemy aircraft ID, a date and time of occurrence, and a hit damage amount. By tracing back the hit damage history data 730, the variables Gh (Ghn, Ght, and Ghint) based on the damage history of the enemy aircraft 6 can be obtained (see FIG. 7).

The damaged object management data 740 is created for each damaged object 12, and stores various types of data related to the damaged object. One piece of the damaged object management data 740 includes, for example, a damaged object ID 741, a part ID list 743, and state value data 745.

The part ID list 743 is a list of the part IDs 541 indicating which parts of the enemy aircraft 6 constitute the damaged object 12. For example, in the case of the left-wing portion 12b, the left-wing portion 12b is made up of a main wing part coupled to a fuselage part of the enemy aircraft 6 as a parent part, an aileron part and a flap part having the main wing part as a parent part, the missile 5 or an auxiliary fuel tank mounted under the wing, and the like. Accordingly, the part ID list 743 includes the part IDs of these parts. If the damaged object 12 is made up of parts finer than the left-wing portion 12b (for example, a single aileron), the part ID list 743 includes only the part ID of the aileron part.

The state value data 745 includes, for example, position coordinates, orientation, a scattering speed V, a current speed, and acceleration of the damaged object 12.

The collateral damage management data 750 is created for each damaged object 12, and stores various types of data for controlling the “collateral destruction” associated with the fall of the damaged object 12.

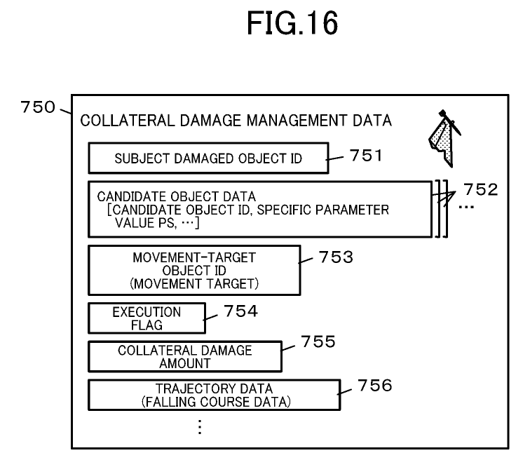

One piece of the collateral damage management data 750 includes, for example, as shown in FIG. 16, a subject damaged object ID 751 indicating the damaged object 12 associated with the corresponding management data, candidate object data 752, a movement-target object ID 753, an execution flag 754, a collateral damage amount 755, and trajectory data 756. Other types of data may also be included in the collateral damage management data 750 as appropriate, of course.

The subject damaged object ID 751 indicates the damaged object 12 associated with the corresponding management data.

The candidate object data 752 is created for each ground object 8 selected as a candidate for the movement-target object 20 from among the ground objects 8 located within a predetermined range from the position of the enemy aircraft 6 that is the source of the damaged object 12. One piece of the candidate object data 752 includes a candidate object ID and a specific parameter value Ps.

The movement-target object ID 753 is the object ID of, from among the candidate objects, the object having the largest specific parameter value Ps.

The execution flag 754 is a flag indicating, based on the result of the probability-based lottery (see FIG. 9), whether the “collateral destruction” caused by the damaged object 12 is to be executed.

The trajectory data 756 is trajectory data representing the trajectory along which the damaged object 12 indicated by the subject damaged object ID falls.

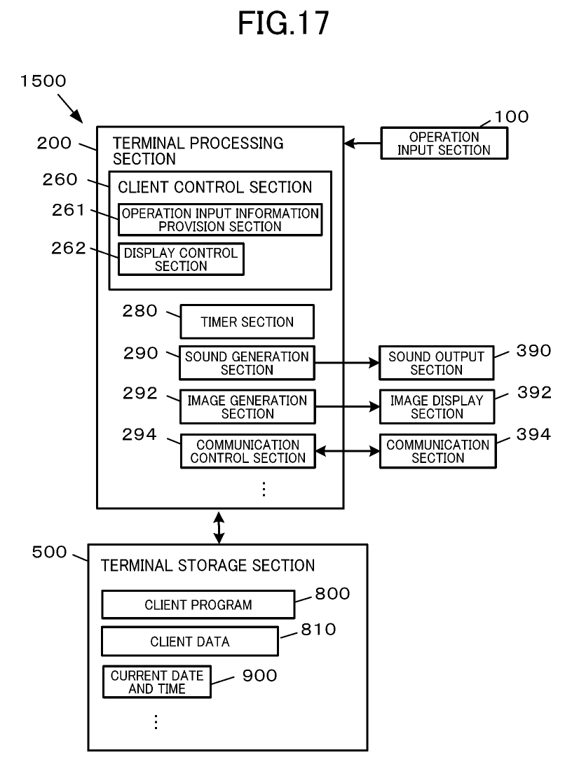

FIG. 17 is a functional block diagram illustrating a functional configuration example of the user terminal 1500. The user terminal 1500 includes the operation input section 100, the terminal processing section 200, the sound output section 390, the image display section 392, the communication section 394, and the terminal storage section 500.

The operation input section 100 outputs operation input signals according to various types of operation inputs made by the player to the terminal processing section 200. The operation input section 100 can be implemented, for example, by a push switch, a touch panel, a joystick, a touch pad, a track ball, an accelerometer, or a gyro.

The terminal processing section 200 is implemented, for example, by a microprocessor such as a CPU or a GPU, and electronic components such as an IC memory. The terminal processing section 200 controls data input/output to/from the functional sections including the operation input section 100 and the terminal storage section 500. The terminal processing section 200 executes various calculation processes based on a predetermined program or data, operation input signals from the operation input section 100, and various types of data received from the server system 1100 to control the operation of the user terminal 1500.

The terminal processing section 200 includes a client control section 260, a timer section 280, a sound generation section 290, an image generation section 292, and a communication control section 294.

The client control section 260 performs various type of control to cause the user terminal 1500 to function as a man-machine interface (MMIF) for control by a client in the game system 1000. Specifically, the client control section 260 includes an operation input information provision section 261 and a display control section 262.

The operation input information provision section 261 performs control for sending operation input information to the server system 1100 according to the input from the operation input section 100.

The display control section 262 performs control for displaying various images based on the data received from the server system 1100.

The timer section 280 uses a system clock to measure the current date and time, limited time periods, or the like.

The sound generation section 290 is implemented, for example, by a processor such as a digital signal processor (DSP) or a sound synthesizing IC, or an audio codec for playing a sound file. The sound generation section 290 generates sound signals for music, sound effects, or various types of operational sounds and outputs the signals to the sound output section 390.

The sound output section 390 is implemented by a device that outputs sound (emits sound) based on the sound signals input from the sound generation section 290, such as a speaker.

The image generation section 292 generates and outputs an image signal for displaying an image on the image display section 392 under the control of the client control section 260. In the example of FIG. 1, a graphics processing unit (GPU), a graphic controller, or a graphic board mounted on the control board 1550 corresponds to the image generation section 292.

The image display section 392 is implemented by a device for displaying images such as a flat panel display, a head-mounted display, or a projector.

The communication control section 294 performs data processing related to data communication, and implements data exchange with an external device through the communication section 394. The communication section 394 connects to the network 9 to implement communication. For example, the communication section 394 is implemented by a wireless communication device, a modem, a terminal adaptor (TA), a jack for wired communication cable, or a control circuit. In the example of FIG. 1, the communication module 1553 corresponds to the communication section 394.

The terminal storage section 500 stores programs, various types of data, and the like, for causing the terminal processing section 200 to implement given functions. The terminal storage section 500 is also used as a work area for the terminal processing section 200, and temporarily stores results of calculations executed by the terminal processing section 200 in accordance with various programs, input data input from the operation input section 100, or the like. These functions are implemented, for example, by an IC memory such as a RAM or a ROM, a magnetic disk such as a hard disk, or an optical disk such as a CD-ROM or a DVD. In the example of FIG. 1, the IC memory 1552 mounted on the control board 1550 corresponds to the terminal storage section 500.

Specifically, the terminal storage section 500 stores a client program 800 (application program) for causing the user terminal 1500 to function as the client control section 260 for the virtual space service, client data 810, and the current date and time 900. Of course, the terminal storage section 500 may store data other than these types of data as appropriate.

The client data 810 is various types of data with which the client control section 260 executes control. The client data 810 includes, for example, a user account, a password, and the like.

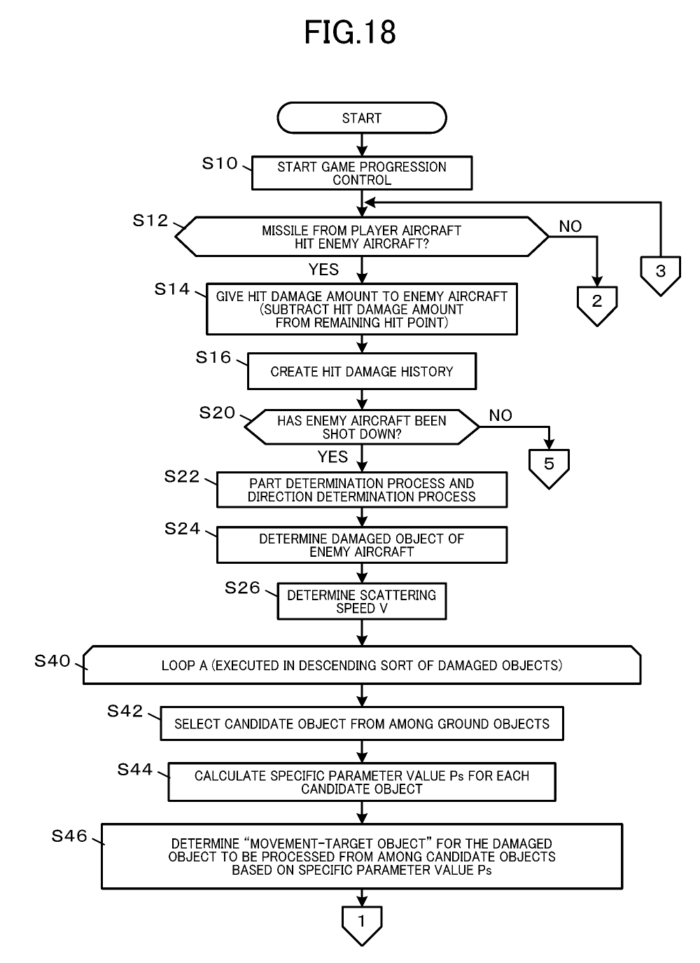

FIGS. 18 to 20 are flowcharts for describing a processing flow executed by the server system 1100.

As shown in FIG. 18, the server system 1100 performs initial installation of the respective objects including the player aircraft 4, the enemy aircraft 6, and the ground objects 8 in the game space 3, which is a virtual three-dimensional space, and starts game progression control (step S10).

When a missile of the player aircraft 4 hits the enemy aircraft 6 (YES in step S12), the server system 1100 determines a hit damage amount to be inflicted on the enemy aircraft 6 and applies the determined hit damage amount (step S14). Then, the server system 1100 creates hit damage history data 730 (step S16).

When, as a result of applying the hit damage amount, the hit point of the enemy aircraft 6 reaches “0” due to a hit by the missile 5 and a shot-down determination is made (YES in step S20), the server system 1100 performs the part determination and the direction determination regarding the hit of the missile 5 (step S22), and determines the damaged object 12 corresponding to the enemy aircraft 6 (step S24).

That is, the server system 1100 refers to the decomposition requirement 546 in the enemy aircraft initial setting data 520E of the enemy aircraft 6, and, when no items of the decomposition requirement 546 are satisfied, sets the damaged object 12 (12g; see FIG. 5) that is the original object 14.

When one or more items of the decomposition requirement 546 thus referred to are satisfied, the part(s) corresponding to the item(s) that satisfied the decomposition requirement 546 are separated from their parent parts, and each is set as the damaged object 12 (12a, 12b, 12c; see FIG. 5). Note that, although the damaged object 12 is determined at this stage, the damaged object has not yet been installed in the game space 3, and, on the game screen, the enemy aircraft 6 hit by the missile 5 remains unchanged.

Then, the server system 1100 sets the scattering speed V for each damaged object 12 (step S26; see FIG. 5).

Then, the damaged objects 12 are sorted in descending order based on their respective physical quantities (for example, the size), and Loop A is executed sequentially from the top of the sorted results (that is, from the damaged object 12 having the largest physical quantity) (steps S40 to S62).

In a loop A, the server system 1100 selects, as the candidate objects, the ground objects 8 within a candidate selection range 28 from the enemy aircraft 6 that has been shot down (step S42; see FIG. 6), and calculates the specific parameter value Ps for each of the candidate objects (step S44).

Then, among the candidate objects, a candidate object that has the largest specific parameter value Ps and has not been selected as the movement-target object 20 is selected and determined as the movement-target object 20 corresponding to the damaged object 12 to be processed by the loop A (step S46).

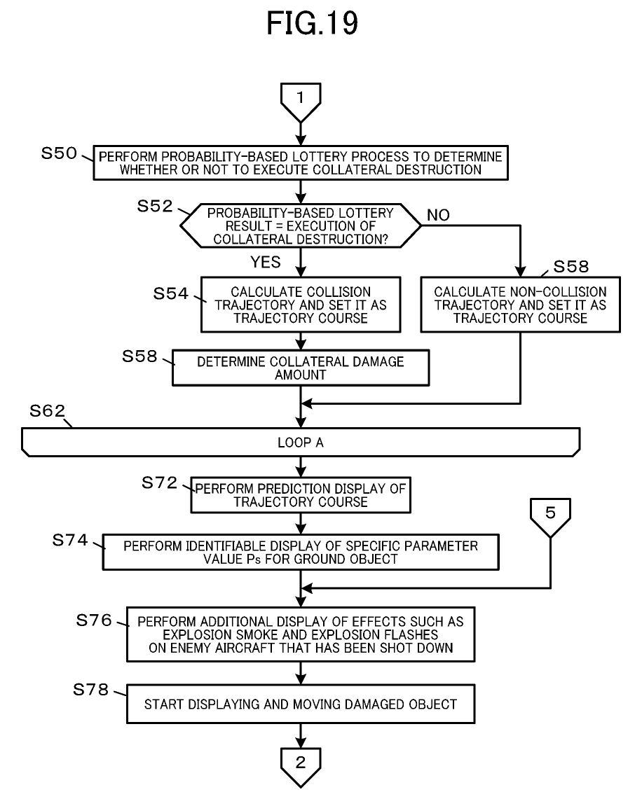

Referring to FIG. 19, the server system 1100 next determines the execution probability based on the specific parameter value Ps of the movement-target object 20, and executes a probability-based lottery process by applying the determined execution probability (step S50; see FIG. 9).

When the result of the probability-based lottery is “execution” (YES in step S52), the server system 1100 sets the movement-target object 20 as the movement-target object, and calculates the collision trajectory 30 by applying the trajectory type 547 (see FIG. 13). Then, the server system 1100 sets the course data of the collision trajectory 30 as the trajectory data 756 (see FIG. 16) of the damaged object 12 that is to be processed by the loop A (step S54). Furthermore, based on the specific parameter value Ps of the movement-target object 20, the server system 1100 determines the collateral damage amount and sets the amount as the collateral damage amount 755 (see FIG. 16) (step S56). Then, the server system 1100 ends the loop A (step S62).

When the result of the probability-based lottery is “non-execution” (NO in step S52), the server system 1100 calculates the non-collision trajectory 32 that deviates from the movement-target object 20. Then, the server system 1100 sets the course data of the non-collision trajectory 32 as the trajectory data 756 of the damaged object 12 that is to be processed by the loop A (step S58), and ends the loop A (step S62).

If the loop A has been executed for each of the damaged objects 12 newly set in relation to the enemy aircraft 6 that has been shot down, it is assumed that the preparation for displaying the crash of the enemy aircraft 6 is completed.

Next, the server system 1100 causes, on the game screen W2 (see FIG. 10), the silhouettes 40 and the prediction displays 42 to be displayed for each damaged object 12 (step S72). Then, on the radar screen 44, the server system 1100 performs the identifiable display based on the specific parameter value Ps of each ground object 8 (step S74).

Next, the server system 1100 additionally displays effects such as explosion smoke or explosion flash on the enemy aircraft 6 that has been shot down as a display of damage caused by the hit of the missile 5 (step S76). Then, the server system 1100 starts display of each damaged object 12 newly set in relation to the enemy aircraft 6, as well as movement control based on the trajectory data 756 (step S78).

By this step, when the damaged object 12 is an original-form object, damaged movement control is performed so that it appears that the enemy aircraft 6 that has been shot down falls by losing control or loss of thrust. When the damaged object 12 is made up of a plurality of partial objects, the damaged movement control is performed such that the enemy aircraft 6 that has been shot down is decomposed while falling with the partial objects being scattered.

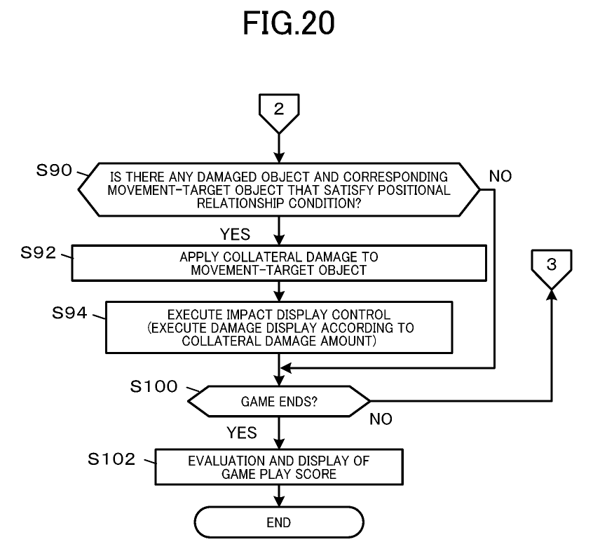

Referring to FIG. 20, the server system 1100 determines whether there is a movement-target object 20 for which a positional relationship condition, which relates to a positional relationship between the damaged object 12 subjected to the damaged movement control, and the movement-target object 20, is satisfied as a result of their contact or movement within a predetermined distance. When it is determined that such a movement-target object 20 exists (YES in step S90), the server system 1100 subtracts the collateral damage amount from the hit point of the movement-target object 20 (step S92).

Next, the server system 1100 executes the impact display control (step S94).

Specifically, the server system 1100 searches, from the impact display definition data 580 in the ground object initial setting data 560 of the corresponding movement-target object 20, for definition data that satisfies the collateral damage amount requirement 581, and displays the collateral damage display 22 in accordance with the retrieved definition.

In addition, when step S94 is performed, the server system 1100 may delete the damaged object 12 detected in step S90 from the game space 3.

If a predetermined game termination condition is not satisfied (NO in step S100), the server system 1100 repeats steps S12 to S100.

When the game termination condition is satisfied (YES in step S100), the server system 1100 evaluates the results of play score and displays the evaluation results (step S102), and then ends the series of processes.

As described above, according to the present embodiment, it is possible to provide a new technique for expressing impacts exerted by a falling object on other object.

In a case where an object (the enemy aircraft 6) flying in the game space 3 “falls” as the damaged object 12, the game system 1000 sets the specific parameter value Ps for each ground object 8 around the enemy aircraft 6 and selects the movement-target object 20. The movement of the damaged object 12 is then controlled on the collision trajectory 30 toward the movement-target object 20. Thereafter, when the damaged object 12 is determined to satisfy a positional relationship condition that indicates contact or approach of the damaged object 12 and the movement-target object 20, the collateral damage display 22 (impact expression) is executed on the movement-target object 20. Accordingly, the movement of the damaged object 12 after it receives the damage varies in different ways depending on the specific parameter value Ps. As a result, various secondary effects occur in accordance with the damage inflicted or damage received.

In addition, the specific parameter value Ps reflects in-game physical quantities, performance values, and state values related to the original object (the enemy aircraft 6) that is falling, other projectile object (the missile 5) that caused the falling object to fall, and the object (the ground object 8) serving as the movement-target object 20. Accordingly, it is possible to diversify the causes of secondary effects that occur in accordance with damage inflicted or damage received.

Further, the specific parameter value Ps reflects a priority that is set for each ground object 8. By appropriately setting the priority, a specific ground object 8 is more likely to be preferentially selected as the movement-target object 20 based on the production intentions of the game creators. Accordingly, spectacular “collateral destruction” can be intentionally caused at a high probability, thereby enhancing the attractiveness of the game.

### Second Embodiment

A second embodiment to which the present invention is applied is described below. The second embodiment is basically implemented in the same manner as the first embodiment; however, the second embodiment differs from the first embodiment in that the game progression control is executed by the user terminal 1500. In the description of the second embodiment, the differences from the first embodiment will be mainly described, and the same components as those in the first embodiment will be given the same referential numerals as in the first embodiment, and duplicate description will be omitted.

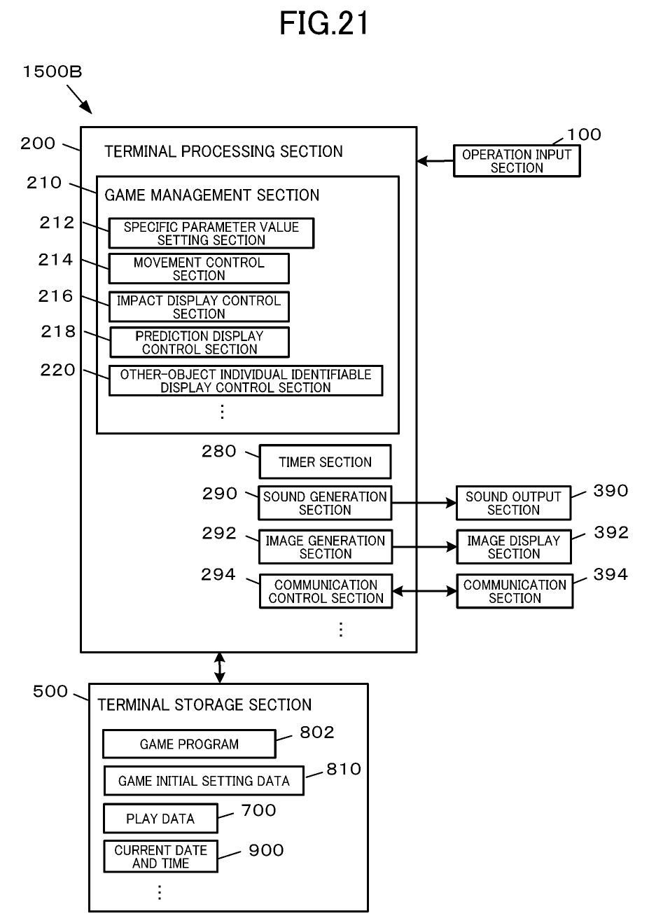

FIG. 21 is a diagram illustrating a functional configuration example of a user terminal 1500B according to the second embodiment.

The user terminal 1500B includes the game management section 210. Accordingly, the user terminal 1500B stores, in the terminal storage section 500, a game program 802 for implementing the functions of the game management section 210, the game initial setting data 510, and the play data 700.

The second embodiment can provide the same advantageous effects as those of the first embodiment.

### Modification Examples

The embodiments to which the present invention is applied have been described above. However, the mode to which the present invention is applicable is not limited to the embodiments described above, and various modifications may be made as appropriate, such as adding other components, or omitting or changing some of the components.

### Modification Example 1

For example, the first embodiment illustrates an example in which the online game is implemented with a client–server system configuration, and the second embodiment illustrates an example in which the game is implemented in a standalone manner; however, the present invention is not limited to these examples. For example, the game may be implemented in a system in which a plurality of user terminals 1500 are connected to each other via P2P (peer-to-peer). In this case, a possible configuration may be such that one of the user terminals 1500 constituting the P2P serves as a host terminal and performs the functions of the server system 1100 of the first embodiment.

### Modification Example 2

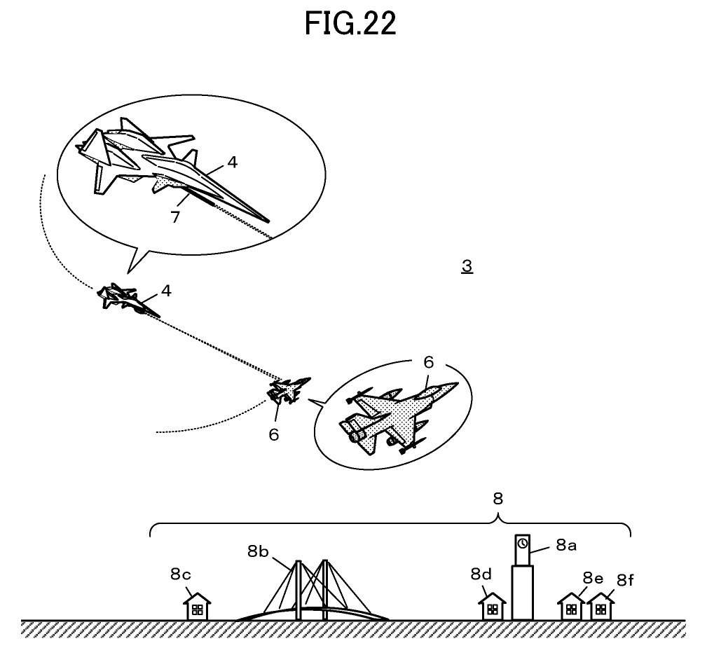

The above embodiments described the missile 5 as an example of damage-inflicting object that inflicts hit damage on the enemy aircraft 6; however, the present invention is not limited to this example. The damage-inflicting object may be a machine-gun bullet (projectile) fired by the player aircraft 4. Further, depending on the setting of the game world, a projectile-type damage-inflicting object may be omitted. For example, in the example of FIG. 22, the player aircraft 4 is equipped with a directional energy weapon 7 and emits a directional energy (for example, a laser) to the enemy aircraft 6 to inflict damage on the enemy aircraft 6. An effect display object that represents the emitted directional energy may also be regarded as a type of projectile. The case where the game world is set in outer space and the game is themed around fleet battles, and the player aircraft 4 is equipped with a charged-particle maneuverable weapon is also similar to the case using the directional energy weapon 7.

### Modification Example 3

The function f (see FIG. 6) for calculating the specific parameter value Ps is not limited a fixed value.

For example, the weighting of each variable may be changed according to the game difficulty level. For example, when the game difficulty is set to "Easy," the priority is given significantly high weight. This makes it possible to create intentional game developments in which even the ground objects 8 oriented in a direction different from the scattering speed V are set as the movement-target objects 20 with a high probability. Further, in the example of FIG. 4, it becomes possible for the player to intentionally lead the subsequent game development to a favorable situation, such as involving the bridge 8b in the collateral destruction to cut off the invasion route of the enemy ground forces.

### Modification Example 4

The above embodiments described the ground objects 8 as examples of the movement-target object 20; however, depending on the configuration of the game stage, a maritime object such as a vessel, or an allied aircraft of the player aircraft 4, may be used as the movement-target object 20. Further, the movement-target object 20 may also be an aerial object as an attack target (for example, a transport aircraft, a tanker aircraft, an airborne control aircraft, an airborne carrier aircraft, a helicopter, an aerial drone, a ballistic missile, a cruise missile, a surface-to-air missile, a rocket, etc.) other than an allied aircraft of the enemy aircraft 6, or a fighter aircraft.

Further, depending on the setting of the game world, the movement-target object 20 may be a fictitious entity. For example, when the game world is set as a fantasy world, the movement-target object 20 may be a fantasy-world entity on land, sea, or in the air (for example, a gigantic monster, a floating island, and the like). When the game world is set in outer space, the movement-target object 20 may be a spacecraft, an artificial satellite, a small space station, a colony, a planet, debris, and the like.

For example, such a situation may be created in which a first moving body (for example, a fighter aircraft A) is shot down, and determination is made as to whether broken pieces of the first moving body strike a second moving body (for example, another fighter aircraft B flying alongside the fighter aircraft A), and, when it is determined that the broken pieces hit the second moving body, the second moving body is destroyed as collateral destruction.

When the movement-target object 20 is a moving body, one or more of a relative distance, a relative azimuth, a relative altitude difference, a relative speed, and a relative size with respect to the moving body may be set as the variable Cst (see FIG. 7) for the candidate objects of the movement-target object 20. When the movement-target object 20 is an entity in a fantasy world, a magical attribute (for example, fire, water, earth, lightning, light, darkness, etc.) and the like may be set as the variable Cst.

By appropriately selecting and setting the variable Cst, it becomes possible, for example, to determine whether broken pieces of the first moving body (for example, fighter aircraft A) will hit the second moving body (for example, another fighter aircraft B flying alongside the fighter aircraft A), based on factors such as the amount of movement, movement direction, movement path, and movement speed of the second moving body.

### Modification Example 5

The game genres and play styles to which the present invention is applicable are not limited to the examples of the above embodiments.

For example, the present invention may be applied not only to a shooting game themed on aerial combat and ground attacks using fighter aircrafts, but also to a multiplayer car racing game in which each player operates a race car.

Specifically, each player aims for the goal while hindering opponents’ driving, for example, by colliding their own vehicle with other vehicle to inflict damage and temporarily reduce its driving performance, or by launching an item from their own vehicle to hit other vehicle and temporarily render the vehicle uncontrollable. A scene in which a player vehicle collides with other vehicle, or a case in which an item hits other vehicle, is regarded as corresponding to a hit of the missile 5 on the enemy aircraft 6 in the above embodiments. By selecting background objects along the side of the course as the movement-target objects 20, it becomes possible to enable damage display in which another vehicle runs off the track while spectacularly involving the background objects along the side of the course.

Similarly, the present embodiment may also be applied to a game that includes damage displays of a type in which a player character or an NPC that has become temporarily uncontrollable upon receiving damage involves surrounding objects.

### Modification Example 6

The variables of the function f for calculating the specific parameter value Ps are not limited to those in the above examples. For example, each time the server system 1100 executes the collateral damage display 22, the server system 1100 may generate impact display history data (for example, data accumulated by associating a ground object ID with an execution date and time). Then, the variables related to the game situation may include a history of executions of the impact display control, the number of times the impact display control has been executed, the intervals at which the impact display control has been executed, and the elapsed time since the last execution of the impact display control.

Specifically, the specific parameter value may be set based on at least one of: (1) the distance between the damaged object and other object, (2) the damage history of the damaged object, (3) the number of occurrences of damage, (4) the interval of occurrences of damage , (5) the elapsed time since the last occurrence of damage, (6) the history of executions of impact display control, (7) the number of times the impact display control has been executed, (8) the interval at which the impact display control has been executed, and (9) the elapsed time since the last execution of the impact display control.

### Modification Example 7

Although the above embodiments described examples of single-player gameplay, the present embodiment may also be similarly applied to multiplayer gameplay. In this case, the player aircraft 4 of each player is handled in the same manner as the enemy aircraft 6 in the above embodiments; that is, the player aircraft 4 may also be shot down and subjected to damage display and the like.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. A computer system comprising at least one processor or circuit programmed to perform:
setting a specific parameter value that is referenced during movement control of a damaged object that moves upon receiving damage in a virtual space;
a movement control of the damaged object with reference to the specific parameter value; and
an impact display control that indicates reception of impact by other object when a given positional relationship condition is satisfied, the positional relationship condition being based on approach or contact of the damaged object and the other object due to the movement control.

2. The computer system as defined in claim 1, wherein
a predetermined gravity field is provided in the virtual space, and
the movement control gradually moves the damaged object in a direction of gravity based on the gravity field.

3. The computer system as defined in claim 1 wherein
the damaged object is any one of:
(1) an original object before receiving the damage;
(2) a partial object that is a part of the original object generated by decomposition or scattering upon receiving the damage; and
(3) a replacement object that is used after the original object is decomposed or scattered upon receiving the damage.

4. The computer system as defined in claim 3, wherein the setting the specific parameter value includes setting the specific parameter value based on at least one of a type, a physical quantity, performance, and a state of the original object.

5. The computer system as defined in claim 1, wherein
a plurality of objects serving as the other object are present in the virtual space, and
the impact display control includes performing the impact display control for the other object that satisfies the positional relationship condition from among the plurality of objects.

6. The computer system as defined in claim 5, wherein the setting the specific parameter value includes setting the specific parameter value corresponding to each of the plurality of objects serving as the other object based on at least one of a priority, a type, a physical quantity, performance, and a state of the other object.

7. The computer system as defined in claim 6, wherein the at least one processor or circuit is programmed to perform a prediction display control includes performing the prediction display of a direction and/or a trajectory in which the damaged object moves due to the movement control,
wherein the prediction display control includes predicting the other object that satisfies the positional relationship condition due to the movement control, and controlling the prediction display based on the specific parameter value corresponding to the other object in a variable manner.

8. The computer system as defined in claim 6, wherein the at least one processor or circuit is programmed to perform an identifiable display for each of the plurality of objects serving as the other object based on the specific parameter value corresponding to the other object.

9. The computer system as defined in claim 6, wherein
the movement control includes
selecting a movement-target object with which the other object serves as a movement target for the damaged object using the specific parameter value corresponding to each of the other object, and
a control to move the damaged object toward the movement-target object.

10. The computer system as defined in claim 1, wherein the at least one processor or circuit is programmed to perform setting the specific parameter value includes setting the specific parameter value based on at least one of a type, a physical quantity, performance, and a state of a damage-inflicting object that has inflicted the damage.

11. The computer system as defined in claim 1, wherein
the virtual space is a game space, and
the setting the specific parameter value includes setting the specific parameter value based on a game situation.

12. The computer system as defined in claim 11, wherein
the setting the specific parameter value includes setting the specific parameter value based on a game situation, which is at least one of: (1) a distance between the damaged object and the other object, (2) a damage history of the damaged object, (3) a number of occurrences of the damage, (4) an interval of occurrences of the damage, (5) an elapsed time since last occurrence of the damage, (6) a history of executions of the impact display control, (7) a number of times the impact display control is executed, (8) an interval at which the impact display control is executed, and (9) an elapsed time since last execution of the impact display control.

13. The computer system as defined in claim 1, wherein
the movement control includes performing control to move the damaged object along a given direction based on a direction in which the damage was received.

14. The computer system as defined in claim 1, wherein the at least one processor or circuit is programmed to perform a prediction display of a direction and/or a trajectory in which the damaged object moves due to the movement control.

15. The computer system as defined in claim 1, wherein
the impact display control includes controlling whether or not to perform the impact display control using the specific parameter value.

16. A control method for a computer system to perform control for generating an image of a virtual space, the method comprising :
setting a specific parameter value that is referenced during movement control of a damaged object that moves upon receiving damage;
performing the movement control of the damaged object with reference to the specific parameter value; and
performing impact display control that indicates reception of impact by other object when a given positional relationship condition is satisfied, the positional relationship condition being based on approach or contact of the damaged object and the other object due to the movement control.
